(19) United States
(12) Patent Application Publication
(10) Pub. No.: US 2026/0106962 A1
(43) Pub. Date: Apr. 16, 2026

(54) PANORAMIC IMAGE GENERATION FOR MIXED REALITY HEADSET USE, MODELING SUBJECTIVE AUDIO QUALITY EVALUATION FOR REAL-TIME APPLICATIONS AND METHODS FOR DISTRIBUTED MESSAGE CONFORMITY IN DISTRIBUTED MACHINE LEARNING MODEL TRAINING AND INFERENCE

(71) Applicant: Meta Platforms Technologies, LLC, Menlo Park, CA (US)

(72) Inventors: Yuchen Fan, Foster City, CA (US); Yilei Li, Fremont, CA (US); Fanyi Xiao, Santa Clara, CA (US); Rakesh Ranjan, Mountain View, CA (US); Xiaoyu Xiang, Foster City, CA (US); Vijay Rengarajan Angarai Pichaikuppan, Sunnyvale, CA (US); Qingyao Jia, San Jose, CA (US); Chao Zhou, Denville, CA (US); Sivakumar Balasubramanian, Dallas, TX (US); Kaustubh Kalgaonkar, Bellevue, WA (US); Jose Antonio Jimenez, Bellevue, WA (US)

(21) Appl. No.: 19/353,540

(22) Filed: Oct. 8, 2025

Related U.S. Application Data
(60) Provisional application No. 63/705,958, filed on Oct. 10, 2024.
(60) Provisional application No. 63/722,293, filed on Nov. 19, 2024.
(60) Provisional application No. 63/724,232, filed on Nov. 22, 2024.

(51) Int. Cl. H04N 13/296; G06F 3/16; H04N 13/139

(52) U.S. Cl. CPC H04N 13/296; G06F 3/162; G06F 3/165; G06F 3/167; H04N 13/139

(57) ABSTRACT

The subject application is at least directed to methods and systems for employing a semi-supervised machine learning model to generate a subject audio quality score for audio obtained via real-time applications. Additionally, various systems, methods, or devices are also described for facilitating communication between one or more nodes in distributed training or inference. In some examples, the method may include sending, by a first node of a plurality of nodes, a message, where the message includes, information associated with the first node of the plurality of nodes. Also, the method may include receiving, from one or more nodes of the plurality of nodes, one or more response messages to the message. Furthermore, the method may include sending, by the first node of the plurality of nodes, data associated with computations at the first node.

### CROSS-REFENCE TO RELATED APPLICATIONS

This application claims the benefit of, U.S. Provisional Application No. 63/722,293, filed Nov. 19, 2024, and U.S. Provisional Application No. 63/724,232, filed Nov. 22, 2024, and U.S. Provisional Application No. 63/705,958, filed Oct. 10, 2024, the entire content of which is incorporated herein by reference.

### TECHNICAL FIELD

The present disclosure generally relates to mixed reality environments, and more particularly to panoramic image generation for mixed reality headset use.

### BACKGROUND

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

A skybox, as displayed using an MR or VR headset, is a high-resolution panoramic image (e.g., 3840×1920 pixels) that represents a mapping of elements of an MR environment onto a sphere surround the headset user. A skybox is often used as a background for additional elements of an MR or VR environment. In a presently available image generation pipeline, the computation cost of generating a skybox is quadratic to the number of pixels. and generating an image of the desired resolution takes an unacceptably long time (e.g., over ten seconds). Thus, there is a need to improve panoramic image generation speed, for use in an MR or VR headset.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement panoramic image generation for mixed reality headset use, according to some exemplary aspects.

FIG. 2 is a block diagram illustrating details of a system for panoramic image generation for mixed reality headset use, according to some exemplary aspects.

FIG. 3 depicts a block diagram of an example configuration for panoramic image generation for mixed reality headset use, in accordance with an illustrative exemplary aspect.

FIG. 4 depicts an example of panoramic image generation for mixed reality headset use, in accordance with an illustrative exemplary aspect.

FIG. 5 depicts a continued example of panoramic image generation for mixed reality headset use, in accordance with an illustrative exemplary aspect.

FIG. 6 depicts a flowchart of an example process for panoramic image generation for mixed reality headset use in accordance with an illustrative exemplary aspect.

FIG. 7 illustrates a diagram of an exemplary network environment in accordance with one or more example aspects of the subject technology.

FIG. 8 illustrates a diagram of an exemplary communication device in accordance with one or more example aspects of the subject technology.

FIG. 9 illustrates an exemplary computing system in accordance with one or more example aspects of the subject technology.

FIG. 10 illustrates a machine learning and training model framework in accordance with example aspects of the present disclosure.

FIG. 11 illustrates a streaming inference with an encoder predictor structure in accordance with one or more example aspects of the subject technology.

FIG. 12 illustrates a smart sampler operation in accordance with one or more example aspects of the subject technology.

FIG. 13 illustrates CPU usage for streaming models versus a sampler versus a non-streaming model in accordance with one or more example aspects the subject technology.

FIG. 14 illustrates OMOS NS*1000 (X-axis) versus background noise surveys at % of total (Y-axis) in accordance with one or more example aspects of the subject technology.

FIG. 15 illustrates an example system in accordance with an example of the present disclosure.

FIG. 16A illustrates an example method in accordance with an example of the present disclosure.

FIG. 16B illustrates an example method in accordance with an example of the present disclosure.

FIG. 17A illustrates an example flow in accordance with an example of the present disclosure.

FIG. 17B illustrates an example flow in accordance with an example of the present disclosure.

FIG. 18 illustrates an example computing device in accordance with an example of the present disclosure.

FIG. 19 illustrates a diagram of an exemplary computing system in accordance with an example of the present disclosure.

FIG. 20 illustrates a machine learning and training model in accordance with an example of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### A. Panoramic Image Generation for Mixed Reality Headset Use

Exemplary aspects of the present disclosure address the above identified problems by implementing panoramic image generation for mixed reality headset use. In particular, an exemplary aspect compresses, using a compression operation, each training panoramic image in a set of training panoramic images into a corresponding compressed training panoramic image; trains, using the set of compressed training panoramic images, a transformer model to generate compressed panoramic images; generates, using the trained transformer model, a first compressed panoramic image; and expands, using an inverse of the compression operation, the first compressed panoramic image into an uncompressed panoramic image.

An exemplary aspect uses a compression operation to compress each training panoramic image in a set of training panoramic images into a corresponding compressed training panoramic image. Because in MR and VR headset use the top and bottom of a panoramic image contain relatively little information about a scene being portrayed in the image, one exemplary aspect compresses each training panoramic vertically, leaving the horizontal dimension unchanged. For example, if the training panoramic images are each 3840×1920 pixels, an exemplary aspect compresses each image into 3840×1280 pixels. To compress an image along the y-axis, for each row of an image, one embodiment computes y=R*tan (j/R), where tan ( ) denotes the tangent operation, R denotes a radius of a sphere, j denotes the current row number of the image, and y denotes the new y coordinate of pixels in this row. In particular, the skybox is an equirectangular image that is mapped to a sphere for VR display. The radius R is the sphere's radius in VR. Since the x-axis of the equirectangular image is mapped to the perimeter of the sphere, the radius R=width/(2*pi).

Using the set of compressed training panoramic images as training data, an exemplary aspect uses a presently available technique to train a transformer model to generate compressed panoramic images. For example, if the training images are 3840×1280 pixels, an exemplary aspect trains the transformer model to generate 3840×1280-pixel images.

Once the transformer model meets one or more training completion criteria, the model is considered trained. Using the trained transformer model, an exemplary aspect generates a first compressed panoramic image from input data, and expands, using an inverse of the compression operation, the first compressed panoramic image into an uncompressed panoramic image. In an exemplary aspect that compresses an image by computing y=R*tan (j/R), the exemplary aspect expands the image by performing the inverse operation, computing y=R*arctan (j/R), where arctan ( ) denotes the arctangent operation and j and R have the same meanings as for the compression operation. An exemplary aspect displays the uncompressed panoramic image using an MR headset.

In one exemplary aspect, the transformer model includes a sequence of layers, also referred to as a pipeline, successively adjusting an image. However, the computation cost of the sequence of layers can be reduced by dividing some layers into sublayers adjusting corresponding portions of an image in parallel with each other. Thus, in another exemplary aspects, a first portion of the pipeline includes one or more transformer layers, each divided into sublayers, with each sequence of sublayers acting in parallel to successively adjust a portion of the image independently of other sublayers adjusting other portions. A second portion of the pipeline includes one or more full-size transformer layers, successively further adjusting the whole image and “stitching together” features on either side of a portion boundary caused by the previous sublayers. A third portion of the image includes one or more transformer layers, each divided into three sublayers, with each sequence of sublayers acting in parallel to successively adjust a portion of the image independently of other sublayers adjusting other portions. Thus, only the middle layers of the pipeline need be full-size, saving computation costs. In one embodiment, if the full-size image is 3840×1280, there are three pipelines of sublayers, each adjusting a 1280×1280 portion of the image. Other exemplary aspects using other numbers of sublayers and sublayer sizes are also possible and contemplated within the scope of the illustrative exemplary aspects.

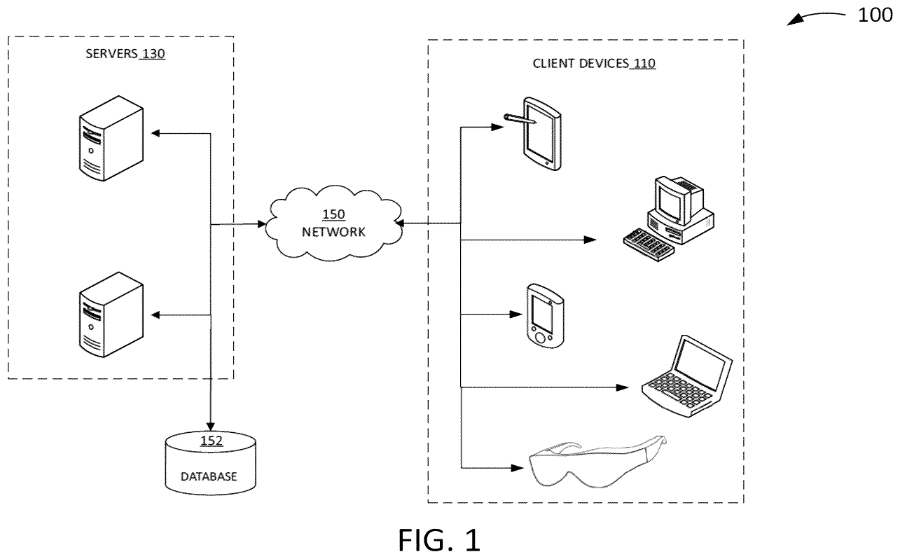

FIG. 1 illustrates a network architecture 100 used to implement panoramic image generation for mixed reality headset use, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some exemplary aspects, the servers 130 may be a cloud server or a group of cloud servers. In other exemplary aspects, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some exemplary aspects, the servers 130 may include the client devices 110 as well, such that they are peers.

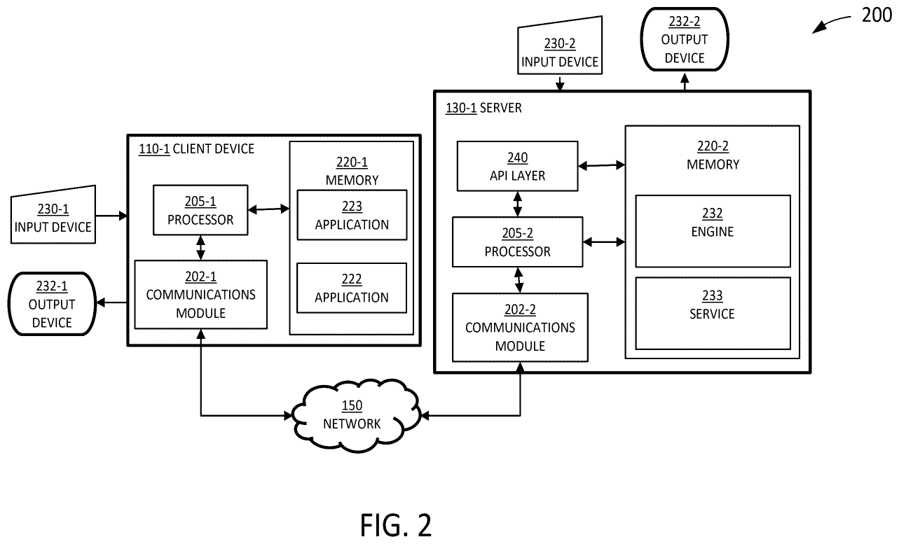

FIG. 2 is a block diagram illustrating details of a system 200 for panoramic image generation for mixed reality headset use, according to some exemplary aspects. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with exemplary aspects of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some exemplary aspects, the input devices 230 may include cameras, microphones, sensors, and the like. In some exemplary aspects, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement panoramic image generation for mixed reality headset use. The application 222 may be downloaded by the user from server 130-1, and/or may be hosted by server 130-1. The application 222 may include specific instructions which, when executed by processor 205-1, cause operations to be performed consistent with embodiments of the present disclosure. In some exemplary aspects, the application 222 runs on an operating system (OS) installed in client device 110-1. In some exemplary aspects, application 222 may run within a web browser. In some exemplary aspects, the processor 205-1 is configured to control a graphical user interface (GUI) (e.g., spanning at least a portion of input devices 230 and output devices 232) for the user of client device 110-1 to access the server 130-1.

In some exemplary aspects, memory 220-2 includes an application engine 232. The application engine 232 may be configured to perform methods and operations consistent with aspects of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide panoramic image generation for mixed reality headset use. The application 223 may communicate with service 233 through API layer 240, for example.

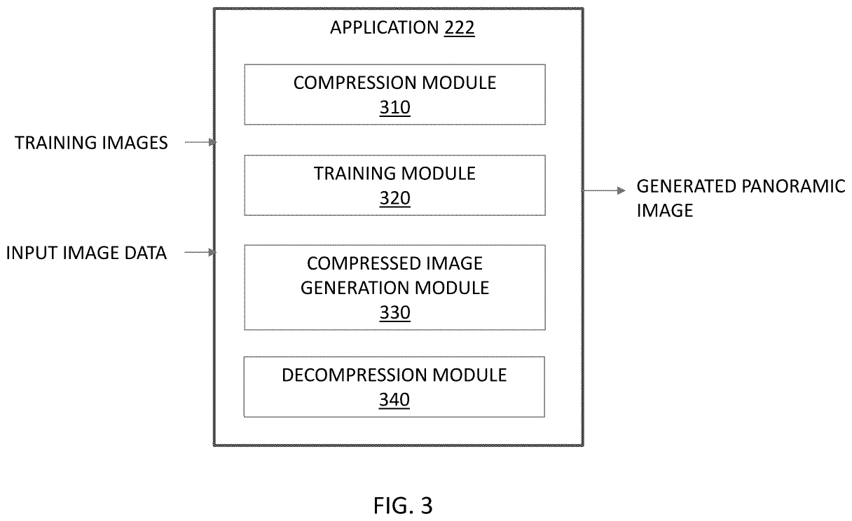

FIG. 3 depicts panoramic image generation for mixed reality headset use, in accordance with an illustrative exemplary aspect. Application 222 is the same as application 222 in FIG. 2.

Compression module 310 uses a compression operation to compress each training panoramic image in a set of training panoramic images into a corresponding compressed training panoramic image. Because in MR and VR headset use the top and bottom of a panoramic image contain relatively little information about a scene being portrayed in the image, one implementation of module 310 compresses each training panoramic vertically, leaving the horizontal dimension unchanged. For example, if the training panoramic images are each 3840×1920 pixels, module 310 compresses each image into 3840×1280 pixels. To compress an image along the y-axis, for each row of an image, module 310 computes y=R*tan (j/R), where tan ( ) denotes the tangent operation, R denotes a radius of a sphere, j denotes the current row number of the image, and y denotes the new y coordinate of pixels in this row. In particular, the skybox is an equirectangular image that is mapped to a sphere for VR display. The radius R is the sphere's radius in VR. Since the x-axis of the equirectangular image is mapped to the perimeter of the sphere, the radius R=width/(2*pi).

Using the set of compressed training panoramic images as training data, training module 320 uses a presently available technique to train a transformer model to generate compressed panoramic images. For example, if the training images are 3840×1280 pixels, module 320 trains the transformer model to generate 3840×1280-pixel images.

Once the transformer model meets one or more training completion criteria, the model is considered trained. Using the trained transformer model, compressed image generation module 330 generates a first compressed panoramic image from input data, and decompression module 340 expands, using an inverse of the compression operation, the first compressed panoramic image into an uncompressed panoramic image. In an implementation that compresses an image by computing y=R*tan (j/R), module 340 expands the image by performing the inverse operation, computing y=R*arctan (j/R), where arctan ( ) denotes the arctangent operation and j and R have the same meanings as for the compression operation. Application 222 displays the uncompressed panoramic image using an MR headset.

In one implementation of application 222, the transformer model includes a sequence of layers, also referred to as a pipeline, successively adjusting an image. However, the computation cost of the sequence of layers can be reduced by dividing some layers into sublayers adjusting corresponding portions of an image in parallel with each other. Thus, in another implementation of application 222, a first portion of the pipeline includes one or more transformer layers, each divided into sublayers, with each sequence of sublayers acting in parallel to successively adjust a portion of the image independently of other sublayers adjusting other portions. A second portion of the pipeline includes one or more full-size transformer layers, successively further adjusting the whole image and “stitching together” features on either side of a portion boundary caused by the previous sublayers. A third portion of the image includes one or more transformer layers, each divided into three sublayers, with each sequence of sublayers acting in parallel to successively adjust a portion of the image independently of other sublayers adjusting other portions. Thus, only the middle layers of the pipeline need be full-size, saving computation costs. In one implementation of application 222, if the full-size image is 3840×1280, there are three pipelines of sublayers, each adjusting a 1280×1280 portion of the image. Other embodiments using other numbers of sublayers and sublayer sizes are also possible and contemplated within the scope of the illustrative exemplary aspects.

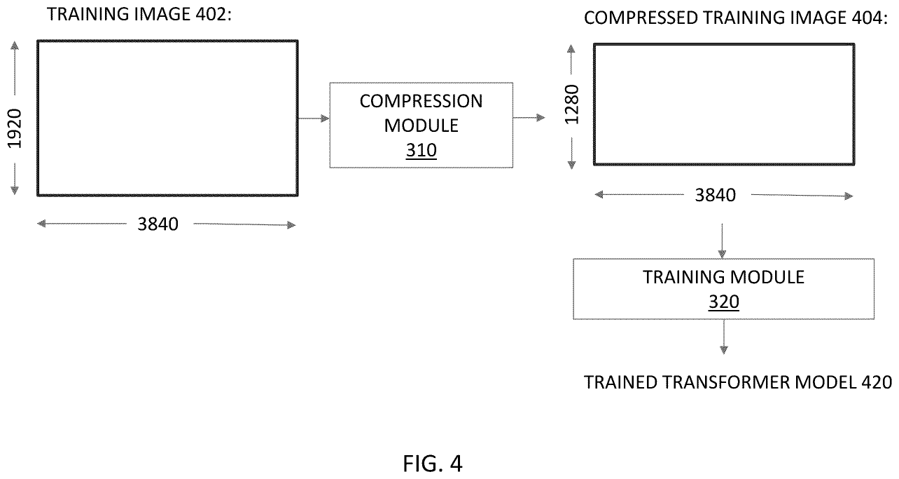

FIG. 4 depicts an example of panoramic image generation for mixed reality headset use, in accordance with an illustrative exemplary aspect. The example can be executed using application 222 in FIG. 2. Compression module 310 and training module 320 are the same as compression module 310 and training module 320 in FIG. 3.

As depicted, training image 402 is 3840×1920 pixels. Compression module 310 compresses training image 402 into compressed training image 404, which is 3840×1280 pixels. Using a set of compressed training panoramic images (including compressed training image 404) as training data, training module 320 uses a presently available technique to train a transformer model to generate compressed panoramic images, here 3840×1280-pixel images. The result is trained transformer model 420.

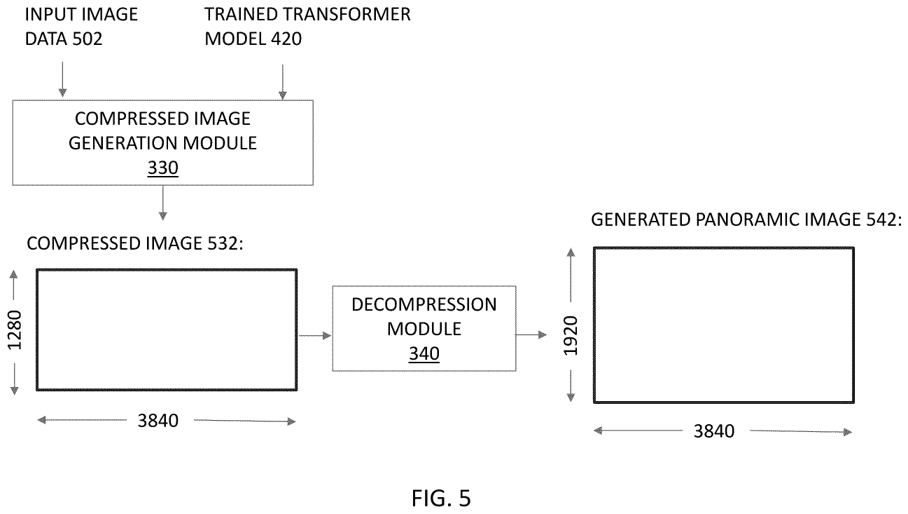

FIG. 5 depicts a continued example of panoramic image generation for mixed reality headset use, in accordance with an illustrative exemplary aspect. Compressed image generation module 330 and decompression module 340 are the same as compressed image generation module 330 and decompression module 340 in FIG. 3. Trained transformer model 420 is the same as trained transformer model 420 in FIG. 4.

Using trained transformer model 420, compressed image generation module 330 generates compressed image 532 from input image data 502, and decompression module 340 expands compressed image 532 into generated panoramic image 542.

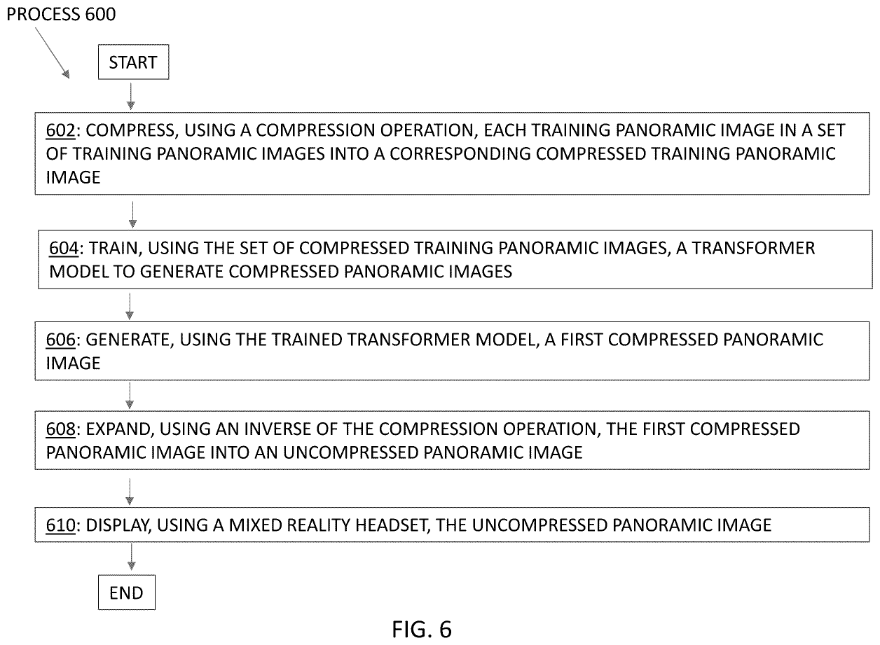

FIG. 6 depicts a flowchart of an example process for panoramic image generation for mixed reality headset use, in accordance with an illustrative exemplary aspect. Process 600 can be implemented in application 222 in FIG. 2.

At block 602, the process compresses, using a compression operation, each training panoramic image in a set of training panoramic images into a corresponding compressed training panoramic image. At block 604, the process trains, using the set of compressed training panoramic images, a transformer model to generate compressed panoramic images. At block 606, the process generates, using the trained transformer model, a first compressed panoramic image. At block 608, the process expands, using an inverse of the compression operation, the first compressed panoramic image into an uncompressed panoramic image. At block 610, the process displays, using a mixed reality headset, the uncompressed panoramic image. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more exemplary aspects, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more exemplary aspects, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more exemplary aspects, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single exemplary aspect. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more exemplary aspects, multitasking and parallel processing may be advantageous. Moreover, the separation of various system components in the exemplary aspects described above should not be understood as requiring such separation in all exemplary aspects, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Clause 1. A computer-implemented method comprising compressing, using a compression operation, each training panoramic image in a set of training panoramic images into a corresponding compressed training panoramic image, the compressing resulting in a set of compressed training panoramic images; training, using the set of compressed training panoramic images, a transformer model to generate compressed panoramic images, the training resulting in a trained transformer model; generating, using the trained transformer model, a first compressed panoramic image; and expanding, using an inverse of the compression operation, the first compressed panoramic image into an uncompressed panoramic image.

Clause 2. The computer-implemented method of clause 1, wherein the compression operation performs a vertical compression of an input image.

Clause 3. The computer-implemented method of clause 1, wherein the inverse of the compression operation expands a compressed input image vertically.

Clause 4. A non-transitory computer-readable medium storing a program, which when executed by a computer, configures the computer to perform the method of any one of clauses 1 to 3.

Clause 5. A system comprising: a processor; and a non-transitory computer readable medium storing a set of instructions, which when executed by the processor, configure the system to perform the method of any one of clauses 1 to 3.

Exemplary aspects consistent with the present disclosure may be combined with any combination of features or aspects of the exemplary aspects described herein.

### B. Modeling Subjective Audio Quality Evaluation for Real-Time Applications

### BACKGROUND

Evaluating audio quality is an important task in real-time communications (RTC). While subjective listening tests are currently considered the gold standard in determining audio quality, they are also time consuming, intrusive and expensive. As a result, subjective listening tests are generally impractical for real-time communications, such as for example, telecommunications and the like.

Efforts to develop automatic methods that match human listener fidelity have been implemented. However, current techniques have drawbacks that limit their implementations in real-world applications.

### SUMMARY

A novel architecture is described in one or more aspects of the subject application that enables an accurate, real-time, non-intrusive, privacy-aware audio quality assessment. In some embodiments, semi-supervised learning techniques are employed to build a joint MOS model that seamlessly covers both PLC and NS scenarios.

In an embodiment, the architecture may be configured to receive audio from a speaker, perform audio processing, encode the audio signal, and transmit the encoded audio signal to a receiver. Audio processing may include performing noise suppression and echo cancellation. A perceived (e.g., subjective) audio quality score may also be added as a quality metric for audio processing modules.

In another embodiment, the architecture may be configured to receive the encoded audio, decode and perform packet loss concealment on the encoded audio, and transmit the decoded audio to a loudspeaker for rendering. An audio quality score may be added as a quality metric for audio processing modules.

### DESCRIPTION

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

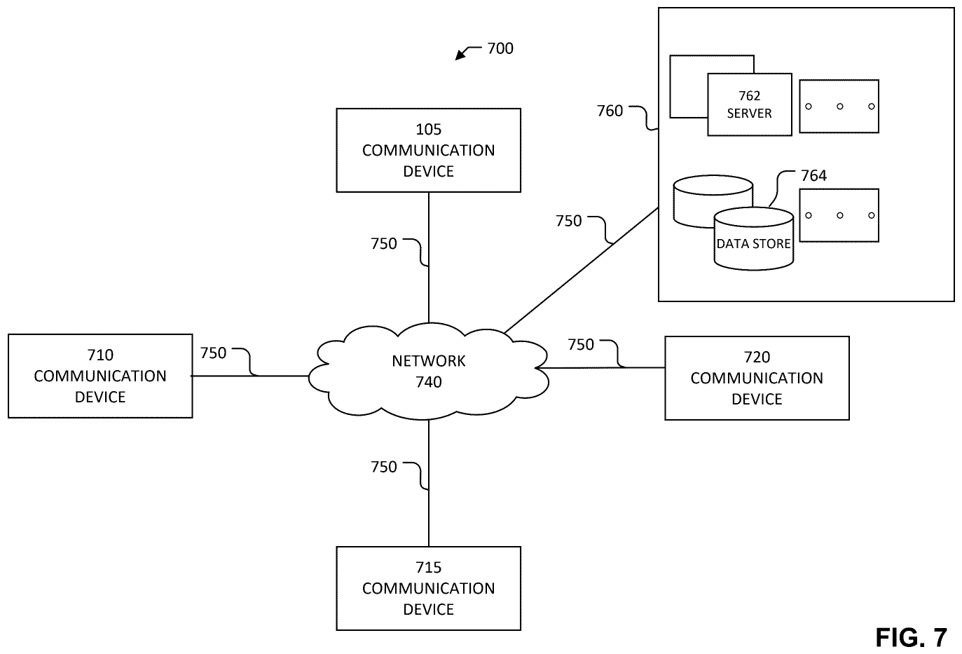

Reference is now made to FIG. 7, which is a block diagram of a system according to exemplary embodiments. As shown in FIG. 7, the system 700 may include one or more communication devices 705, 710, 715 and 720 and a network device 760. Additionally, the system 700 may include any suitable network such as, for example, network 740. In some examples, the network 740. In other examples, the network 740 may be any suitable network capable of provisioning content and/or facilitating communications among entities within, or associated with the network 740. As an example and not by way of limitation, one or more portions of network 740 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 740 may include one or more networks 740.

Links 750 may connect the communication devices 705, 710, 715 and 720 to network 740, network device 760 and/or to each other. This disclosure contemplates any suitable links 750. In some exemplary embodiments, one or more links 750 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 750 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout system 100. One or more first links 750 may differ in one or more respects from one or more second links 750.

In some exemplary embodiments, communication devices 705, 710, 715, 720 may be electronic devices including hardware, software, or embedded logic components or a combination of two or more such components and capable of carrying out the appropriate functionalities implemented or supported by the communication devices 705, 710, 715, 720. As an example, and not by way of limitation, the communication devices 705, 710, 715, 720 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 705, 710, 715, 720 may enable one or more users to access network 740. The communication devices 705, 710, 715, 720 may enable a user(s) to communicate with other users at other communication devices 705, 710, 715, 720.

Network device 760 may be accessed by the other components of system 100 either directly or via network 740. As an example, and not by way of limitation, communication devices 705, 710, 715, 720 may access network device 760 using a web browser or a native application associated with network device 760 (e.g., a mobile social-networking application, a messaging application, another suitable application, or any combination thereof) either directly or via network 740. In particular exemplary embodiments, network device 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 762 may include hardware, software, or embedded logic components or a combination of two or more such components for carrying out the appropriate functionalities implemented and/or supported by server 762. In particular exemplary embodiments, network device 760 may include one or more data stores 764. Data stores 764 may be used to store various types of information. In particular exemplary embodiments, the information stored in data stores 764 may be organized according to specific data structures. In particular exemplary embodiments, each data store 764 may be a relational, columnar, correlation, or other suitable database. Although this disclosure describes or illustrates particular types of databases, this disclosure contemplates any suitable types of databases. Particular exemplary embodiments may provide interfaces that enable communication devices 705, 710, 715, 720 and/or another system (e.g., a third-party system) to manage, retrieve, modify, add, or delete, the information stored in data store 764.

Network device 760 may provide users of the system 700 the ability to communicate and interact with other users. In particular exemplary embodiments, network device 760 may provide users with the ability to take actions on various types of items or objects, supported by network device 760. In particular exemplary embodiments, network device 760 may be capable of linking a variety of entities. As an example, and not by way of limitation, network device 760 may enable users to interact with each other as well as receive content from other systems (e.g., third-party systems) or other entities, or allow users to interact with these entities through an application programming interfaces (API) or other communication channels.

It should be pointed out that although FIG. 7 shows one network device 760 and four communication devices 705, 710, 715 and 720, any suitable number of network devices 760 and communication devices 705, 710, 715 and 720 may be part of the system of FIG. 7 without departing from the spirit and scope of the present disclosure.

### Exemplary Communication Device

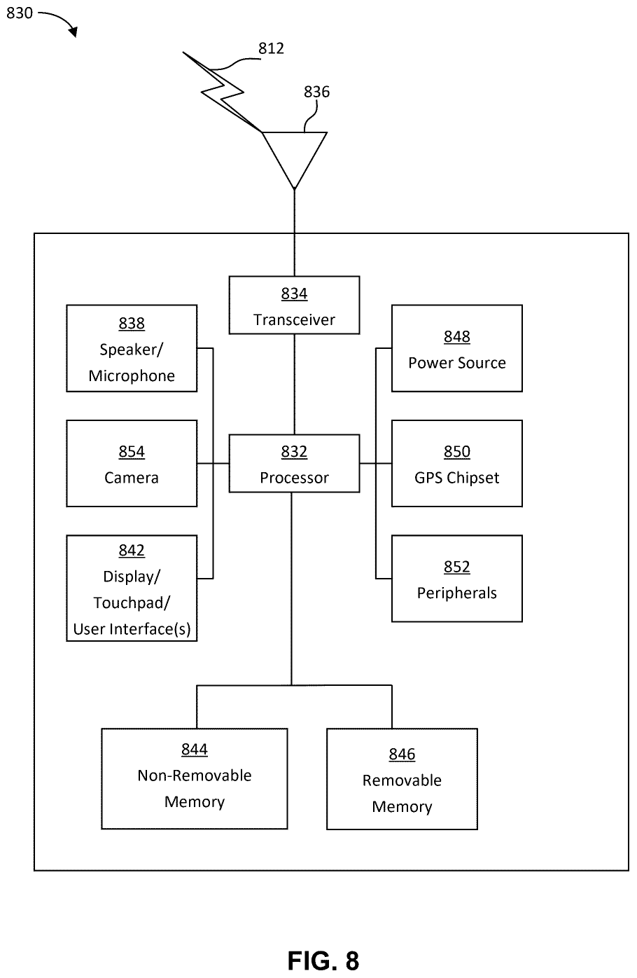

FIG. 8 illustrates a block diagram of an exemplary hardware/software architecture of a communication device such as, for example, user equipment (UE) 830. In some exemplary respects, the UE 830 may be any of communication devices 705, 710, 715, 720. In some exemplary aspects, the UE 830 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 8, the UE 830 (also referred to herein as node 830) may include a processor 832, non-removable memory 844, removable memory 846, a speaker/microphone 838, a display, touchpad, and/or user interface(s) 842, a power source 848, a GPS chipset 850, and other peripherals 852. In some exemplary aspects, the display, touchpad, and/or user interface(s) 842 may be referred to herein as display/touchpad/user interface(s) 842. The display/touchpad/user interface(s) 842 may include a user interface capable of presenting one or more content items and/or capturing input of one or more user interactions/actions associated with the user interface. The power source 848 may be capable of receiving electric power for supplying electric power to the UE 830. For example, the power source 848 may include an alternating current to direct current (AC-to-DC) converter allowing the power source 848 to be connected/plugged to an AC electrical receptacle and/or Universal Serial Bus (USB) port for receiving electric power. The UE 830 may also include a camera 854. In an exemplary embodiment, the camera 854 may be a smart camera configured to sense images/video appearing within one or more bounding boxes. The UE 830 may also include communication circuitry, such as a transceiver 834 and a transmit/receive element 836. It will be appreciated the UE 830 may include any sub-combination of the foregoing elements while remaining consistent with an embodiment.

The processor 832 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 832 may execute computer-executable instructions stored in the memory (e.g., non-removable memory 844 and/or removable memory 846) of the node 830 in order to perform the various required functions of the node. For example, the processor 832 may perform signal coding, data processing, power control, input/output processing, and/or any other functionality that enables the node 830 to operate in a wireless or wired environment. The processor 832 may run application-layer programs (e.g., browsers) and/or radio access-layer (RAN) programs and/or other communications programs. The processor 832 may also perform security operations such as authentication, security key agreement, and/or cryptographic operations, such as at the access-layer and/or application layer for example. The non-removable memory 844 and/or the removable memory 846 may be computer-readable storage mediums. For example, the non-removable memory 844 may include a non-transitory computer-readable storage medium and a transitory computer-readable storage medium.

The processor 832 is coupled to its communication circuitry (e.g., transceiver 834 and transmit/receive element 836). The processor 832, through the execution of computer-executable instructions, may control the communication circuitry in order to cause the node 830 to communicate with other nodes via the network to which it is connected.

The transmit/receive element 836 may be configured to transmit signals to, or receive signals from, other nodes or networking equipment. For example, in an exemplary embodiment, the transmit/receive element 836 may be an antenna configured to transmit and/or receive radio frequency (RF) signals. The transmit/receive element 836 may support various networks and air interfaces, such as wireless local area network (WLAN), wireless personal area network (WPAN), cellular, and the like. In yet another exemplary embodiment, the transmit/receive element 836 may be configured to transmit and/or receive both RF and light signals. It will be appreciated that the transmit/receive element 836 may be configured to transmit and/or receive any combination of wireless or wired signals.

The transceiver 834 may be configured to modulate the signals that are to be transmitted by the transmit/receive element 836 and to demodulate the signals that are received by the transmit/receive element 836. As noted above, the node 30 may have multi-mode capabilities. Thus, the transceiver 834 may include multiple transceivers for enabling the node 830 to communicate via multiple radio access technologies (RATs), such as universal terrestrial radio access (UTRA) and Institute of Electrical and Electronics Engineers (IEEE 802.11), for example.

The processor 832 may access information from, and store data in, any type of suitable memory, such as the non-removable memory 844 and/or the removable memory 846. For example, the processor 832 may store session context in its memory, (e.g., non-removable memory 844 and/or removable memory 46) as described above. The non-removable memory 844 may include RAM, ROM, a hard disk, or any other type of memory storage device. The removable memory 846 may include a subscriber identity module (SIM) card, a memory stick, a secure digital (SD) memory card, and the like. In other exemplary embodiments, the processor 832 may access information from, and store data in, memory that is not physically located on the node 830, such as on a server or a home computer.

The processor 832 may receive power from the power source 848 and may be configured to distribute and/or control the power to the other components in the node 830. The power source 848 may be any suitable device for powering the node 830. For example, the power source 848 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 832 may also be coupled to the GPS chipset 850, which may be configured to provide location information (e.g., longitude and latitude) regarding the current location of the node 830. It will be appreciated that the node 830 may acquire location information by way of any suitable location-determination method while remaining consistent with an exemplary embodiment.

### Exemplary Computing System

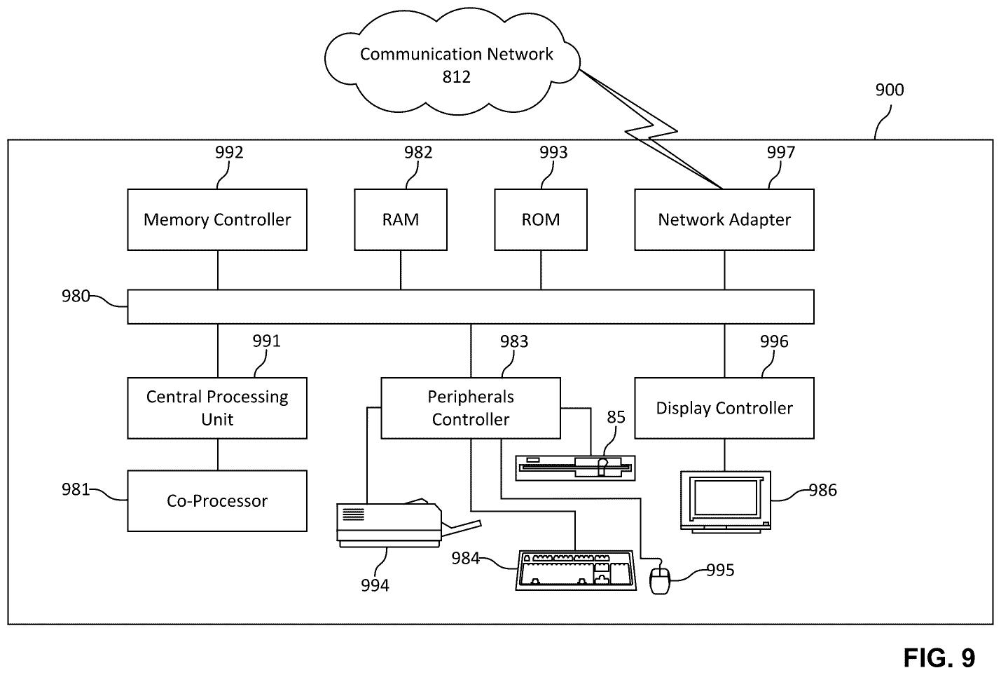

FIG. 9 is a block diagram of an exemplary computing system 900. In some exemplary embodiments, the network device 760 may be a computing system 900. The computing system 900 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 991, to cause computing system 900 to operate. In many workstations, servers, and personal computers, central processing unit 991 may be implemented by a single-chip CPU called a microprocessor. In other machines, the central processing unit 991 may comprise multiple processors. Coprocessor 981 may be an optional processor, distinct from main CPU 991, that performs additional functions or assists CPU 991.

In operation, CPU 991 fetches, decodes, and executes instructions, and transfers information to and from other resources via the computer's main data-transfer path, system bus 980. Such a system bus connects the components in computing system 900 and defines the medium for data exchange. System bus 980 typically includes data lines for sending data, address lines for sending addresses, and control lines for sending interrupts and for operating the system bus. An example of such a system bus 980 is the Peripheral Component Interconnect (PCI) bus.

Memories coupled to system bus 980 include RAM 982 and ROM 993. Such memories may include circuitry that allows information to be stored and retrieved. ROMs 993 generally contain stored data that cannot easily be modified. Data stored in RAM 982 may be read or changed by CPU 991 or other hardware devices. Access to RAM 982 and/or ROM 993 may be controlled by memory controller 992. Memory controller 992 may provide an address translation function that translates virtual addresses into physical addresses as instructions are executed. Memory controller 992 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 900 may contain peripherals controller 983 responsible for communicating instructions from CPU 991 to peripherals, such as printer 994, keyboard 984, mouse 995, and disk drive 985.

Display 986, which is controlled by display controller 996, may be used to display visual output generated by computing system 900. Such visual output may include text, graphics, animated graphics, and video. The display 986 may also include or be associated with a user interface. The user interface may be capable of presenting one or more content items and/or capturing input of one or more user interactions associated with the user interface. Display 986 may be implemented with a cathode-ray tube (CRT)-based video display, a liquid-crystal display (LCD)-based flat-panel display, gas plasma-based flat-panel display, or a touch-panel. Display controller 996 includes electronic components required to generate a video signal that is sent to display 986.

Further, computing system 900 may contain communication circuitry, such as for example a network adapter 997, that may be used to connect computing system 900 to an external communications network, such as network 812 of FIG. 8, to enable the computing system 900 to communicate with other nodes (e.g., UE 830) of the network.

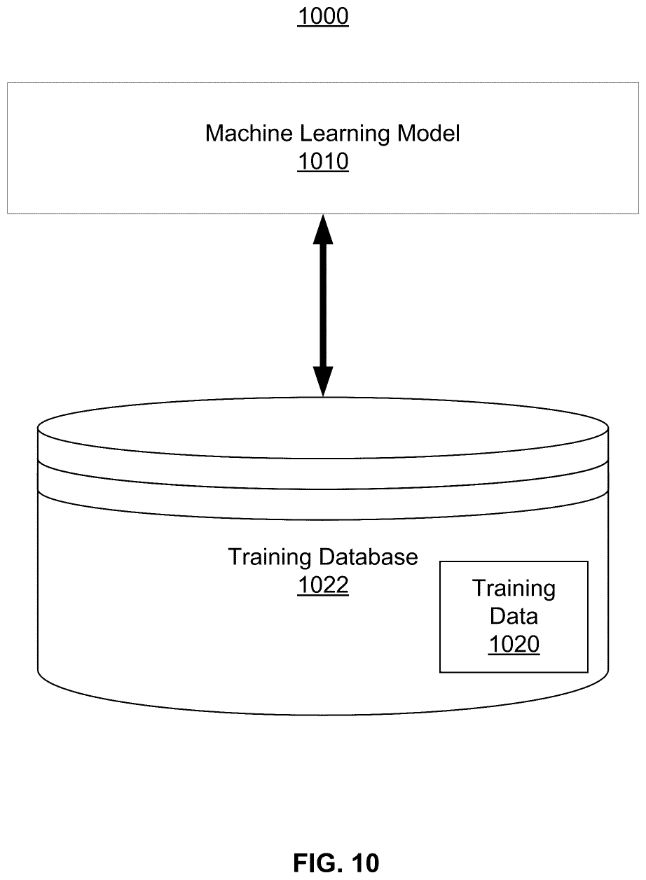

FIG. 10 illustrates a machine learning (ML) and training model, in accordance with an example of the present disclosure. The machine learning framework 1000 associated with the machine learning model may be hosted remotely. Alternatively, the machine learning framework 1000 may reside within a server 762 shown in FIG. 7, or be processed by an electronic device (e.g., head mounted displays, smartphones, tablets, smartwatches, or any electronic device, such as communication device 705). The machine learning model 1010 may be communicatively coupled to the stored training data 1020 in a memory or database (e.g., ROM, RAM) such as training database 1022. In some examples, the machine learning model 1010 may be associated with operations of any one or more of the systems/architectures depicted in subsequent figures of the application. In some other examples, the machine learning model 1010 may be associated with other operations. The machine learning model 1010 may be implemented by one or more machine learning models(s) and/or another device (e.g., a server and/or a computing system). In some embodiments, the machine learning model 1010 may be a student model trained by a teacher model, and the teacher model may be included in the training database 1022.

### Quality Score Prediction ML Model

According to an aspect of the instant application, a system architecture may include an on-device ML model configured to predict a quality score upon audio processing sound. This may involve noise suppression, codec and echo cancellation in the audio pipeline. The ML model provides audio quality scores and other audio characteristics that will help determine audio quality degradation.

One of the technical solutions in the subject application involves building a unified model for predicting audio quality specific to noise suppression and packet loss concealment in the RTC pipeline using semi-supervised training techniques. As a result, a perceived audio quality estimation is obtained, albeit without a clean reference. It is modeled to correlate to subjective scores which are the gold standard for evaluation. The architecture is configured to score various RTC audio algorithms in real-time. It is aimed to provide insights about audio quality degradations after every processing module in the RTC pipeline.

Another one of the technical solutions in the subject application involves improving detectability. One measure is if any messages are displayed related to audio quality. Another measure if it provides particular surveys tailored to the user experience in the call without the user giving any prior inputs.

According to an embodiment of the subject application, a single low-footprint on-device model that predicts human subjective ratings for NS and PLC APMs using semi-supervised training techniques is described. The model may provide specific scores for each APM, with datasets collected separately and labeled specifically for each module. In support, the application provides details on developing the combined model and compares its performance to standalone PLC and NS models. Additionally, the application describes techniques used to deploy this model on-device without CPU overloads using streaming inference and a state machine based sampling technique.

According to an embodiment of subject application, it is envisaged that measurement of quality is important in developing any audio processing system, algorithms or modules. The metric to measure perceived audio quality can differ based on the focus of audio processing modules (APM). For noise suppression (NS) systems, one may be interested in measuring presence of residual noise and speech degradation due to aggressive NS. For Packet Loss Concealment (PLC) or Acoustic Echo Cancellation (AEC) one may want to assess the quality impact in the presence of artifacts and distortions to human speech. It is envisaged that subjective tests may yield the most accurate insights into the performance of the systems.

### Dataset for Model

A labeled dataset is an important component for development of the instant architecture of the subject application. The data collection/labeling process is designed with two major requirements: 1) To guarantee that the scores obtained across various sessions and raters are comparable and normalized. This process control ensures that models trained using our dataset are capturing the quality scores and not just the variability/noise in the scoring process. 2) Maximize the diversity in the processing, scenarios and locales.

The model employs a dataset to assess audio quality in various scenarios, including NS, AEC, and PLC. A subset of the dataset features a single primary speaker. There is another subset of data that targets special scenarios, such as multiple speakers or equalization, which is not the primary focus of this work. The overall collection comprises approximately 400000 labels, spanning eleven languages. Each utterance is typically 10 seconds long and is evaluated by multiple trained raters (ten per clip). During a session, raters are presented with only one task (e.g., either NS or PLC), which consisted of ten to fifteen utterances. A short calibration exercise is conducted at the start of each session, and raters have access to the reference utterances throughout the exercises. To prevent listener fatigue, a limit is placed on the number of sessions that could be assigned to each rater.

For the dataset related to noise suppression APM, the exemplary aspects aim to capture not only the overall audio quality but also the quality of the main speaker and the impact of noise. To achieve this, the exemplary aspects design questions that specifically focused on each aspect including but not limited to Speech MOS (SMOS): Quality of main speaker; Noise MOS (NMOS): Quality as impacted by presence of noise; or Overall MOS (OMOS): Overall audio quality.

A smaller amount of data (⅓ the size of NSMOS data) with simulated packet loss and concealment artifacts such as robotic audio was also employed. The raters are instructed to just score these utterances for overall quality (i.e., OMOS).

For each processing type, the dataset is divided into training, validation, and testing sets in a 70:15:15 ratio, ensuring that the distribution is maintained across languages and locales.

Speakers and utterances in each group are unique, and the test data is held back for final evaluations. The results presented in this paper are based solely on the test data.

### Model Training

All of the subjective audio quality evaluation for real-time applications (SMARTMOS) models are trained to predict quality scores for an audio clip that is around 10 seconds. The model's inputs are log-mel features computed over a 20 ms frame that is generated with 10 ms overlap. The exemplary aspects use 1024 size FFT and ablate over the number of mel-banks, details of this experiment are captured in Section V. All the models use Adam optimizer and MSE loss for training. The exemplary aspects use the mean of the ratings from all raters per audio clip as the label for training and testing the models.

Standalone small models are trained to achieve low memory and computational efficiency for both Noise Suppression MOS (NSMOS) and Packet Loss Concealment MOS (PLCMOS). The model architecture is similar to DNSMOS, with the number of outputs of the model varied according to the processing type. It is observed that replacing the global max pool layer with a global average pool layer yields improved results in this setup. These group of models use 40 filter banks. Due to the limited availability of PLCMOS data, transfer learning techniques are employed, wherein the model is initially trained on the overall dataset and subsequently finetuned with the PLC dataset

Larger SMARTMOS models are trained to examine the effects of increased receptive field and improved context utilization. A secondary objective is to determine whether these larger models could be leveraged to augment the training set with semi-supervised labels. This investigation entails the use of higher-resolution input, incorporating larger input filter banks (e.g., 40, 80, and 120), as well as deeper and wider network architectures. Furthermore, SMARTMOS models with emformer layers are trained to compare and contrast the attention mechanism with convolutional neural networks (CNNs) for the tasks, providing insight into the relative strengths of each approach.

An emformer is a transformer architecture variant that uses a fixed-length context window to attend to the input sequence, rather than attending to the entire sequence at once. In emformers, the left and right context lengths determine the number of time steps the model considers before and after the current time step when processing the input sequence. The segment size represents the chunk of the input sequence processed in the current time step. These parameters primarily impact the analysis context for the emformer, while the number of layers affects long-range dependencies. Feature stacking is a technique used to increase context per time step by concatenating past and future time step features with the present time step. The receptive field can be controlled using both feature stacking and context lengths.

SMARTMOS models trained for on-device deployment are based on CNN architecture. One goal is to train a single model to predict both the PLC and NS MOS scores. As explained in section II PLC (OMOS only) and NS data set have different types of MOS labels which complicates the joint model training.

A semi-supervised approach is envisaged to overcome this label mismatch issue by training a single SMARTMOS model with four output targets: three outputs for NS scores and one for predicting the OMOS for PLC and using the large emformer models trained for NS and PLC cases as teachers to predict pseudo-labels that can be used to fill in the missing targets. This kind of semi-supervised learning techniques have been successfully applied in many domains. Table 1 below explains the process used to combine human-labels and pseudo-labels during joint training in a four score model for each dataset. A three output version may also be employed which combines the OMOS scores for both NS and PLC.

TABLE 1

| Data | OMOS NS | OMOS PLC | N and S MOS |
|---|---|---|---|
| NSMOS | Human ratings | PLCMOS | Human ratings |
| | | Emformer | |
| PLCMOS | NSMOS | Human ratings | NSMOS |
| | Emformer | | Emformer |

According to another embodiment, the SMARTMOS model is developed with the aim to deploy it in VOIP apps so the exemplary aspects can understand, monitor and improve quality of audio services. To ensure a seamless calling experience for the user the models are run efficiently on-device and have minimal impact on memory, CPU and battery. These aims are achieved by implementing a smart strategy to select audio segments, rate limiting number of MOS evaluations during a call and restructuring the SMARTMOS model to prevent single shot processing of 10 seconds audio data.

In an embodiment, the selection of the best available 10 second segment of audio is done by using a voice activity detector (VAD) in combination with a small state machine 2. The sampler operates with predetermined action in one of the three states: “speech,” “silence,” and “null”. While in “speech” state the sampler actively buffers the frames of processing if voice activity is present otherwise it transitions to “silence” sate. The sampler only invalidates the buffered data if “silence” detected for X seconds and the sampler then transitions to “null” state. As seen from the figure the exemplary aspects build stickiness in each state to prevent unnecessary invalidation of accumulated audio. The exemplary aspects also use the sampler to rate limit the MOS evaluations to Y in Z minutes. The exemplary aspects initialize the sampler from the “null” state at the start of the call. The values of parameters are X, Y and Z are tuned heuristically.

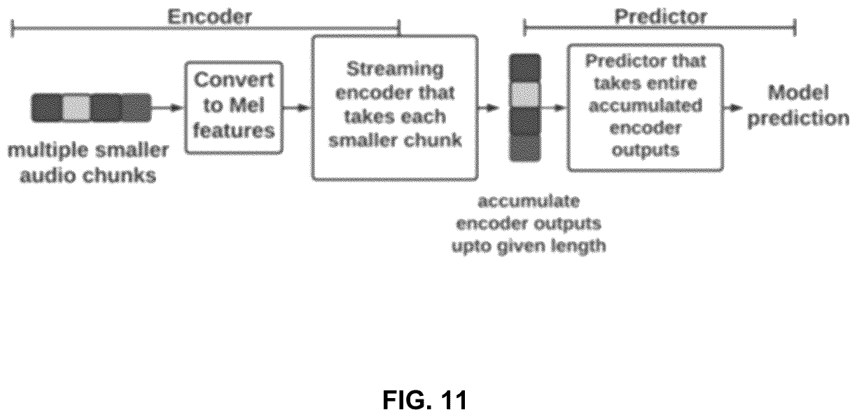

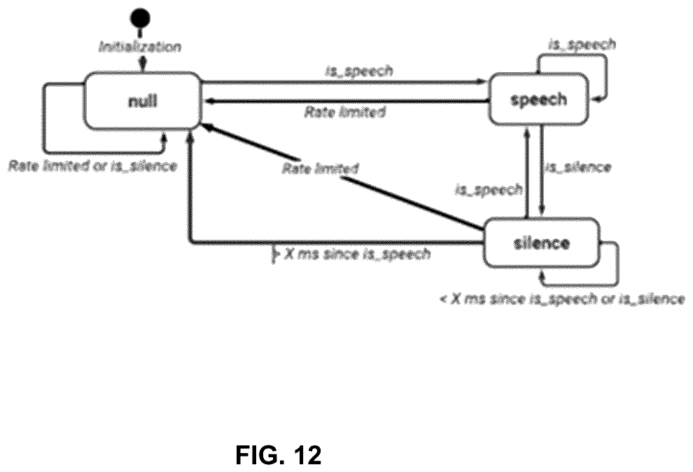

In another exemplary aspect, evaluating over 10 second segment of audio in single shot causes unnecessary spike in CPU. To address this, the model is split into two parts: (i) encoder, which contains all the convolution layers, and (ii) predictor, which has the fully connected components as depicted in FIG. 11. FIG. 11 depicts streaming inference with an encoder predictor structure. FIG. 12 depicts a smart sampler operation. The input audio segment is split into chunks (e.g., 0.1 seconds each) and processed through the encoder at a slower rate, the embedding from the encoder are accumulated and processed in single shot when the embedding for full segments are available.

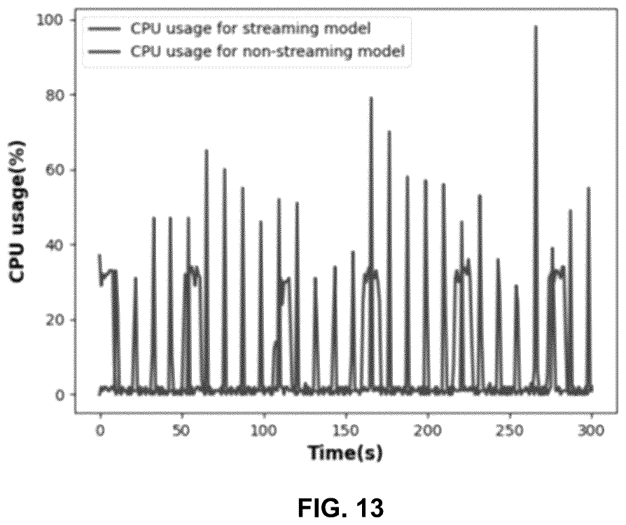

In yet another embodiment, the CPU usage of the streaming model is compared with state machine based sampling against the non-streaming model on-device. As shown in FIG. 13, the modified model's CPU usage remains within a range and predicts Y times every Z minute, whereas the non-streaming model peaks every 10 seconds, which is not desirable for a real-time system.

According to yet another embodiment, the Pearson Correlation Coefficient (PCC) was employed in the subject application to compare the correlation between the mean scores from human raters and the model's MOS predictions per audio clip. Specifically, Table 2 presents the correlations of the top-performing CNN and emformer models. The results are calculated on the held-out test sets corresponding to each dataset. Notably, the joint MOS model with four scores outperforms the standalone NSMOS model for the NS task and achieves comparable performance to the standalone PLCMOS models for the PLC task. This improvement is attributed to the inclusion of semi supervised labels from the best offline models. In contrast, the joint three scores model shows a degradation in the OMOS PLC correlation, which may be due to data imbalance between the two datasets or differences in the quality prediction task between the APMs. While the emformers exhibit slightly better correlations, this comes at the cost of a significant increase in the number of parameters. Moreover, using an NSMOS model for scoring PLC datasets yields poor correlations (around 50%) and vice versa.

TABLE 2

| | | OMOS | OMOS | | |
|---|---|---|---|---|---|
| MOS Type | # Param | NS | PLC | NMOS | SMOS |
| PLC CNN | 45K | NA | 85.1 | NA | NA |
| PLC CNN | 68K | NA | 84.1 | NA | NA |
| PLC EMF | 1M | NA | 85.5 | NA | NA |
| NS CNN | 45K | 90.8 | NA | 87.8 | 89.7 |
| NS CNN | 68K | 91.2 | NA | 89.1 | 89.2 |
| NS EMF | 1M | 92.9 | NA | 91.6 | 91.5 |
| joint CNN | 45K | 91.5 | 82.3 | 89.7 | 89.8 |
| (3S) | | | | | |
| joint CNN | 45K | 91.9 | 84.6 | 90.1 | 90.3 |
| (4S) | | | | | |

TABLE 3

| LMEL | # Layers | [L, R] | OMOS |
|---|---|---|---|
| 120 (FS) | 5 | [10, 1] | 92.2 |
| | 2 | [10, 1] | 91.7 |
| | 2 | [4, 1] | 91.5 |
| | 3 | [10, 1] | 92.6 |
| 40 (FS) | 2 | [10, 1] | 91.5 |
| | 10 | [4, 1] | 92.1 |
| 40 | 3 | [4, 1] | 90.1 |

| LMEL | # Layers | [L, R] | OMOS | SMOS | NMOS |
|---|---|---|---|---|---|
| 40 (FS) | 3 | [10, 1] | 92.9 | 91.5 | 91.5 |
| 120 (FS) | 3 | [10, 1] | 92.9 | 91.5 | 91.6 |
| | 9 | [10, 1] | 92.7 | 91.2 | 91.7 |
| | 3 | [30, 2] | 92.8 | 91.4 | 91.4 |
| | 9 | [30, 2] | 92.2 | 91.1 | 90.7 |

Ablations were conducted on the emformers by fixing the segment size to ten and varying the left and right context lengths as well as the number of emformer layers. The exemplary aspects use three frames from the previous time steps and concatenate them with the current time step as stacked features. Experiments were performed for standalone NSMOS models with just the OMOS score (Table 3) as well as the three scores (Table 4).

In comparison to CNNs, emformers have a larger receptive field as they take the entire feature dimension for predictions over a chunk of time steps. This difference is more pronounced when using more filter banks or feature stacking. Our results show that models rely more heavily on information within local receptive fields than on long-range dependencies, with significant improvements in correlations coming from feature stacking. Predicting the three scores together also improves OMOS correlations. However, increasing the receptive field through feature stacking or context lengths comes at a high computational cost. The best-performing emformers have nearly one million parameters (Table 2), making CNNs a better choice for on-device deployments due to their lower computational requirements.

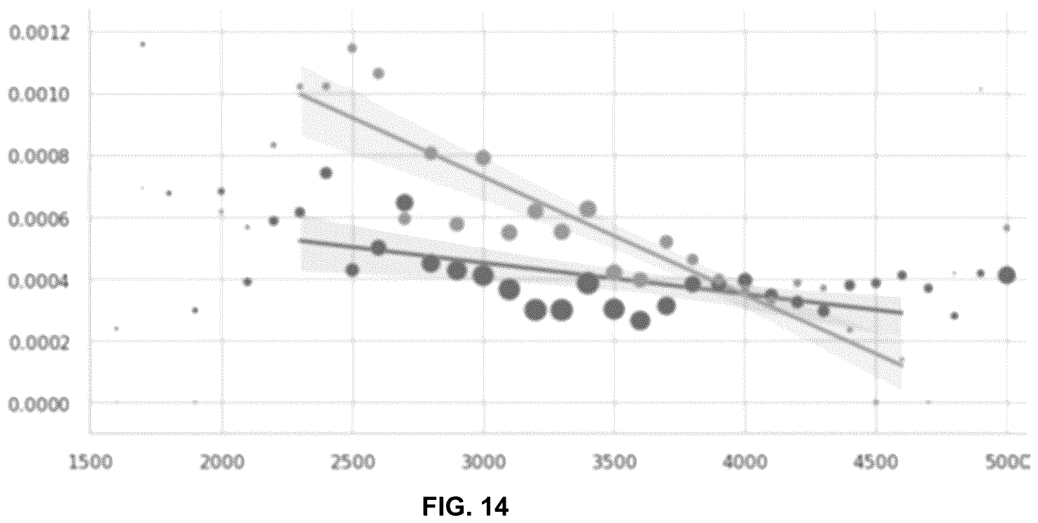

Over 200,000 real-time calls on two platforms were studied and analyzed, correlating OMOS NS with the ratio of background noise feedback in surveys. The ratio indicates the number of callers with noise complaints. A lower ratio implies fewer noise issues. According to one embodiment, a negative correlation between OMOS and background noise surveys is understood, suggesting users submit fewer surveys when quality is better and vice versa thereby making MOS a good alternative for filling gaps in sparse surveys. FIG. 14 illustrates OMOS NS*1000 (X-axis) versus background noise surveys at % of total (Y-axis) in accordance with one or more example aspects of the subject technology.

SMARTMOS may be trained as a single joint audio quality prediction model for rating both Noise Suppression and Packet Loss Concealment APMs in real-time telecommunication, using semi-supervised techniques. The exemplary aspects demonstrate techniques that make the SMARTMOS model work on-device without increasing CPU load and show correlation analysis with metrics from real-time calls. Additionally, it is determined emformers with larger receptive fields slightly outperform CNNs but at a high computational cost, making CNNs a better choice for on device deployments.

### C. Methods for Distributed Message Conformity in Distributed Machine Learning Model Training and Inference

### TECHNOLOGICAL FIELD

The present disclosure generally relates to methods, apparatuses, and computer program products for facilitating communication between computing resources, specifically implementing machine learning models.

### BACKGROUND

Electronic devices are constantly changing and evolving to provide users with flexibility and adaptability. Many electronic devices may provide methods or systems for users to utilize an artificially intelligent (AI) platforms to request content or information of interest. In some examples, the users' request may require a number of machine learning models to work in tandem to provide the content or information associated with the request. In some examples, one or more of the machine learning models may be associated with one or more entities, users, developers, organizations, or the like.

### SUMMARY

Although, machine learning models are becoming more standard, the data structure (e.g., tensors) of every machine learning model may differ depending on the associated entity. In many instances where a number of machine learning models may be utilized to respond to a request, a syncing protocol may be used where the participating machine learning models may send out information associated with the machine learning model (e.g., data structure or any other suitable information). In some examples, this syncing protocol may work, however, often times this protocol may result in miscommunication between the machine learning models, application crash, or system crash.

Disclosed herein are methods, systems, or apparatuses, that may establish a common language (e.g., format) and protocol between one or more nodes to facilitate the exchange of data, which may be used to generate a response to a request in AI systems. Various systems, methods, and devices are described for facilitating communication between one or more nodes in distributed training or inference.

In an example, systems and methods may include sending, by a first node of a plurality of nodes, a message. The message may comprise information associated with the first node of the plurality of nodes. In response to sending the message, one or more response messages may be received from one or more nodes of the plurality of nodes. The one or more response messages may comprise synchronization information. The first node may send, to the one or more nodes of the plurality of nodes, data associated with computations at the first node.

In an example, systems and methods may include receiving, by a plurality of nodes, a message. The message may comprise information associated with a first node of a plurality of nodes. The method may further include, sending from one or more nodes of the plurality of nodes to the first node, one or more response messages. The one or more response messages may be sent in response to the received message. The one or more response messages may comprise synchronization information. The one or more nodes of the plurality of nodes may receive, from the first node, data associated with computations at the first node. The plurality of nodes may execute computations based on the synchronization information to generate a response.

### DESCRIPTION

It is to be understood that the methods and systems described herein are not limited to specific methods, specific components, or to particular implementations. It is also to be understood that the terminology used herein is for the purpose of describing particular embodiments only and is not intended to be limiting.

In the technology field of distributed training or inference associated with machine learning models, efficient communication between one or more nodes may be important to receiving informed AI responses. Tensors may be used in these distributed communications to synchronize states and information. Conventionally, each node participating in the communication sends out local data to groups of peers, such as all peer ranks in a process group, with the assumption that all peers will understand the message or data format.

However, syncing protocols may require that the information sent out adheres to specific formats and sizes. One syncing protocol, for instance, is the ‘all_gather’ operation. This conventional syncing protocol may require that tensors from all peers (e.g., all nodes in the system that may communicate) have the same shape. This requirement may pose a significant challenge in heterogenous environment. Sending out syncing information without knowledge of what other nodes or peers may lead to miscommunication between nodes. As such, miscommunications may result in application or system crashes, thereby hindering the efficiency and reliability of distributed machine learning systems.

As such there may be a need for a method of communication and synchronization among one or more computing resources (e.g., devices, nodes, processors, or the like) in a distributed machine learning system. Disclosed herein are methods, systems, or apparatuses, that may establish a common language (e.g., format) and protocol between one or more nodes to facilitate the exchange of data, which may be used to generate a response to a request in AI systems.

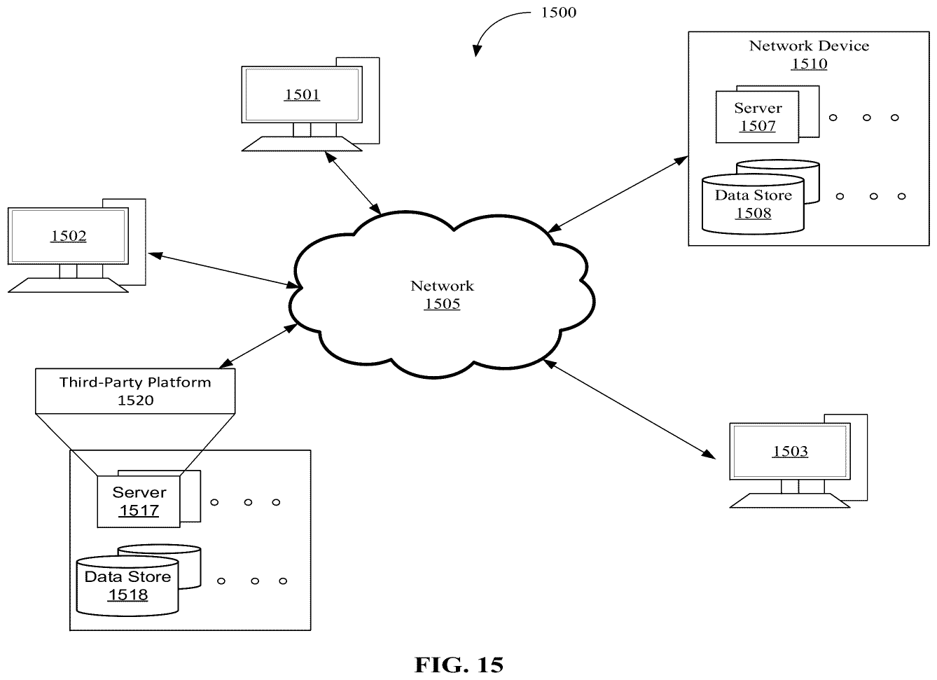

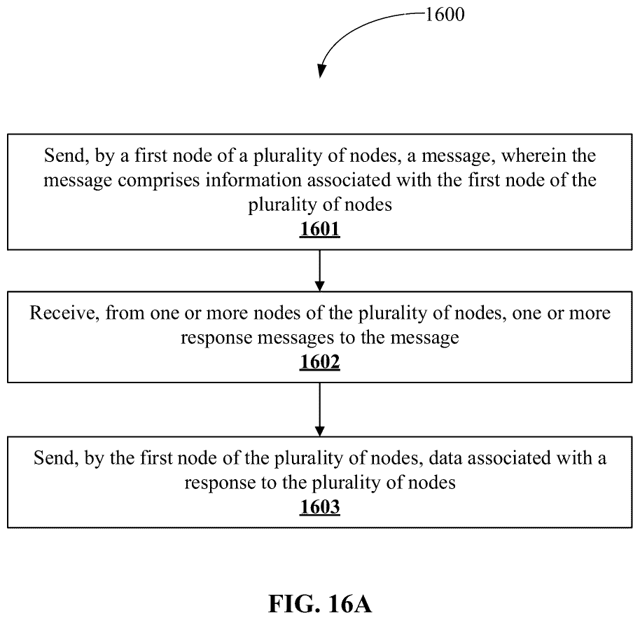

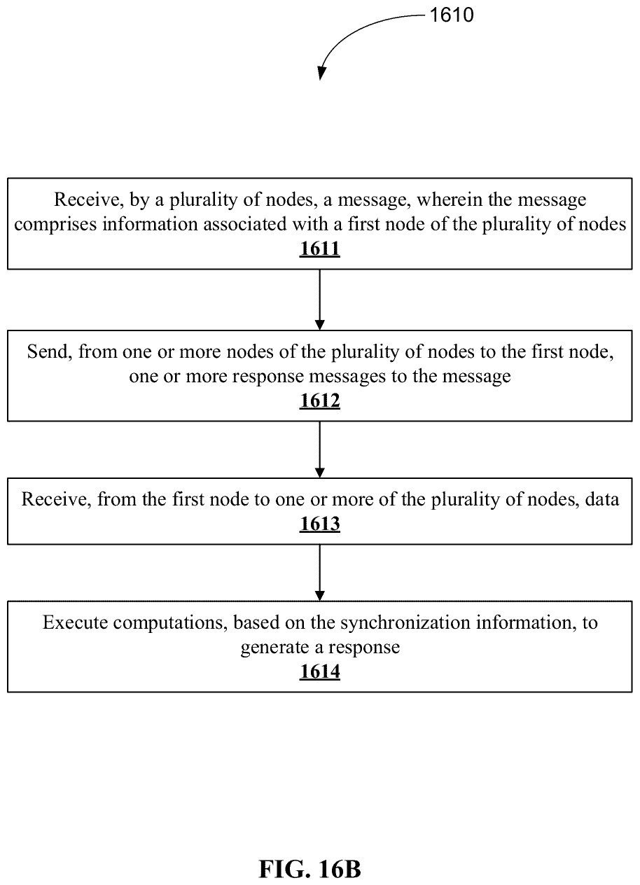

FIG. 15 illustrates an example system 1500 according to example aspects of the present disclosure. The system 1500 may be capable of facilitating the transmission of data among nodes, entities, users, servers, databases, processor, or any suitable computing resource or any combination thereof. The system 1500 may include one or more communication devices 1501, 1502, 1503 (also may be referred to herein as user devices 1501, 1502, 1503), server 1507, data store 1508, network device 1510, server 1517, data store 1518, or third-party platform 1520. In some examples, communication devices 1501, 1502, and 1503 may be any suitable computing resource such as but not limited to, a general processing unit (GPU), a central processing unit (CPU), a machine learning system, nodes, computing device, or the like, or any combination thereof. In an example, communication devices 1501, 1502, and 1503 may be examples of user equipment (UE) (e.g., UE 1630 of FIG. 16). As shown for simplicity, network device 110 may comprise one or more servers (e.g., server 1507) and one or more data stores (e.g., data store 1508). As shown for simplicity, third-party platform 1520 may be located on server 1517 or interact with one or more devices of system 1500. In some examples, it is contemplated that the network device 1510 may be a standalone device. In other examples, the network device 1510 may be located on a server. It is contemplated that network device 1510 may interact and/or communicate with one or more devices (e.g., communication devices 1501, 1502, 1503) of system 1500.

In some examples, communication device 1501, communication device 1502 and communication device 1503 may be associated with an individual (e.g., a user), entity (e.g., organization), developer, machine learning model, computing resource, or the like, or any combination thereof that may be utilized in an artificially intelligent (AI) platform associated with an application, web browser, or the like, associated with the network device 1510. The network device 1510 may be considered, or associated with, an application(s), platforms(s), a communication module(s), and/or the like. In some examples, one or more machine learning models (e.g., communication device 1501, communication device 1502, communication device 1503) may access, send data to, and/or receive data from network device 1510. In some examples, one or more entities may use one or more devices (e.g., communication device 1501, communication device 1502, communication device 1503) to access, send data to, and/or receive data from network device 1510.

This disclosure contemplates any suitable network 1505. As an example and not by way of limitation, one or more portions of network 1505 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 1505 may include one or more networks 1505.

The communication devices 1501, 1502 and 1503 may be a computing resource including hardware, software, or embedded logic components or a combination of two or more such components and capable of carrying out the appropriate functionalities implemented or supported by the communication devices 1501, 1502, 1503. As an example and not by way of limitation, communication devices 1501, 1502, 1503 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., communication devices 1501, 1502, 1503). One or more of the communication devices 1501, 1502, 1503 may be configured to access network 1505. One or more of the communication devices 1501, 1502, 1503 may be configured to communicate with other devices at other communication devices 1501, 1502, 1503 via network 1505.

The communication devices 1501, 1502, 1503 may be configured to store or cause output of at least a portion of a response. The output of at least a portion of a response (e.g., a tensor associated with a machine learning model) may be caused by a request associated with a user. The communication devices 1501, 1502, 1503 may be configured to send information to one or more other communication devices 1501, 1502, 1503. The information may include a type, a shape, a list, a plural, or any other suitable data associated with a communication device 1501 (e.g., first node 1701). The information associated with the communication 1501 may define a format that may be supported by the communication device 1501 (e.g., a type, a shape, a list, or a plural associated with the output of the communication device 1501. The information may be sent to communication devices 1501, 1502, 1503 via a message. A type may refer to the data type or format of the output, such as but not limited to an integer, a float, a string, a tensor, or the like. Some examples of a type may be float32, float 16, Int8, or any other suitable type. A shape may refer to the dimension and structure of the output, such as a scalar, vector, matrix, tensor, or the like. Some examples of a shape may be NHWC, NCHW, batch-first, or any other suitable shape. A list may be a collection of multiple values, tensors, scalars, strings, or the like, which may be represented by multiple predictions, multi-output models, sequence data, or the like. A plural may refer to multiple outputs or instances of a particular type of data type, such as but not limited to: multiple objects, multiple classes, multiple sequences, or the like.

The communication devices 1501, 1502, 1503 may be configured to send synchronization information to allow synchronization of output of at least a portion of the response between a plurality of devices (e.g., communication devices 1501, 1502, 1503). The synchronization information may comprise one or more of a type, a shape, a list, a plural, or any other suitable synchronization information associated with the plurality of devices (e.g., communication devices 1501, 1502, 1503). The synchronization information associated with the plurality of devices may define a synchronized format (e.g., a common language) that may be supported by one or more of the plurality of devices. The synchronized format may comprise a type, a shape, a list, or a plural associated with the output of one or more of the plurality of devices. For example, a first device (e.g., communication device 1501) may send a message comprising information associated with the first device 1501 to a plurality of devices (e.g., communication devices 1502, 1503). The information may be stored in a database (e.g., data store 1508). In some examples, previously stored information may be updated based on a new message comprising new information. In some examples, information received may update data previously stored in the database 1508. In response to receiving the message the plurality of devices (e.g., communication devices 1502, 1503) may send synchronization information to the first device (e.g., communication device 1501).

The information or the synchronization information may be stored via a database (e.g., data store 1508) or server (e.g., server 1507). In some examples, the information or the synchronization information may be stored temporarily or permanently based on the system 1500. The communication devices 1501, 1502, 1503 may be configured to send a message. The message may be considered a broadcast message associated with discovering or communicating with associated devices (e.g., devices 1501, 1502, 1503) that may be associated with determining a response to a request. The message may be sent based on (e.g., in response to) a request from a user, received from a third-party platform 1520. The message may comprise information associated with the device that sends the message. The message may be sent to one or more communication devices (e.g., devices 1501, 1502, 1503) associated with a network 1505. In some examples, the message may be sent via a first node 1701.

In particular examples, system 1500 may include one or more servers 1507, 1517. Each of the servers 1507, 1517 may be a unitary server or a distributed server spanning multiple computers or multiple datacenters. Servers 1507, 1517 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 1507, 1517 may include hardware, software, or embedded logic components or a combination of two or more such components for carrying out the appropriate functionalities implemented or supported by server 1507, 1517.

In particular examples, system 1500 may include one or more data stores 1508, 1518. Data stores 1508, 1518 may be used to store various types of information. In particular examples, the information stored in data stores 1508 may be organized according to specific data structures. In particular examples, each of the data stores 1508, 1518 may be a relational, columnar, correlation, or other suitable database. Although this disclosure describes or illustrates particular types of databases, this disclosure contemplates any suitable types of databases. Particular examples may provide interfaces that enable communication devices 1501, 1502, 1503 or another system (e.g., a third-party system) to manage, retrieve, modify, add, or delete, the information stored in data store 1508, 1518. In some examples, the communication devices 1501, 1502, 1503 may comprise a data store 1508.

In some examples, network device 1510 may be a network-addressable computing system that may host an online communication network. The network device 1510 may store, receive, process, or analyze communication device (e.g., device 1501, 1502, 1503) information. In examples, network device 1510 may facilitate data interactions between processors, computing devices, entities (e.g., organizations), or the like, or any combination thereof. In an example, the network device 1510 may retrieve data from databases (e.g., data store 1508) and execute data mining processes or methods to extract information associated with the data. The network device 1510 may be configured to receive information associated with one or more communication devices 1501, 1502, 1503. The network device 1510 may be configured to retrieve, process, send, or analyze information based on a request associated with a third-party platform (e.g., a social media platform, artificially intelligent platform (AI), a messaging platform, or the like). The network device 1510 may be utilized to aid in determining a response to the request. To determine the response, the network device 1510 may retrieve relevant data from databases (e.g., data store 1508), servers (e.g., server 1507), communication devices 1501, 1502, 1503, or any other device of system 1500, or any combination thereof.

In some examples, network device 1510 may be configured to assess and receive one or more requests, which may be associated with a user profile. The one or more requests may refer to an input that may provide a description, definition, context, and/or structure associated with the request. The one or more requests may include, text, audio, or video, one or more responses to previous requests, or the like, or any combination thereof. In some examples, network device 1510 may be configured to utilize the received request to determine one or more machine learning models (e.g., device 1501, 1502, 1503) may be utilized to form one or more responses to the request.

In particular examples, third-party platform 1520 may be a network-addressable computing system that may host an online social media platform, marketplace, shop, and/or the like. Third-party platform 1520 may generate, store, receive, or send information associated with a user, such as, for example, user-profile data or other suitable data related to third-party platform 1520. Third-party platform 1520 may send information associated with a request provided by a user. Third-party platform 1520 may be accessed by one or more components of system 1500 directly or via network 1505. As an example, and not by way of limitation, third-party platform 1520 may be located on server 1517, where a user may access the third-party platform by using a web browser or a native application (e.g., a mobile social networking application, a messaging application, another suitable application, or any combination thereof) directly or via network 1505.

Third-party platform 1520 may provide users with the ability to take actions on various types of items. As an example, and not by way of limitation, the items may include groups to which a user may belong, messaging boards in which a user might be interested, question forums, messages between one or more users, interactions with images, stories, videos, comments under a post, or other suitable items. A user may interact with anything that is capable of being represented in third-party platform 1520. In particular examples, third-party platform 1520 may be capable of linking a variety of users. As an example, and not by way of limitation, Third-party platform 1520 may enable users to interact with each other as well as receive content (e.g., media, text, or the like, or any combination thereof) from their respective group or contacts, wherein the group may refer to a chosen plurality of users are communicating or interacting through application programming interfaces (API) or other communication channels to each other.

Although FIG. 15 illustrates a particular arrangement of communication device 1501, communication device 1502, communication device 1503, network 1505, server 1507, data store 1508, network device 1510, server 1517, data store 1518, or third-party platform 1520, among other things, this disclosure contemplates any suitable arrangement. The devices of system 1500 may be physically or logically co-located with each other in whole or in part.

It should be pointed out that although FIG. 15 shows one network device 1510, server 1507, data store 1508 and three communication devices 1501, 1502, and 1503, any suitable number of network devices 1510, communication devices 1501, 1502, 1503, servers 1507, and data stores 1508 may be part of the system 1500 of FIG. 15 without departing from the spirit and scope of the present disclosure

FIG. 16A and FIG. 16B illustrate an example method 1600 and an example method 1610, respectively, for facilitating communication between a plurality of nodes (e.g., communication devices 1501, 1502, 1503) as disclosed herein. The method 1600 or method 1610 may be initiated (e.g., triggered) in response to a request on a platform. The platform may be associated with a network device (e.g., network device 1510), a server (e.g., server 1507), or any other suitable device associated with the system 1500. For the platform to generate one or more responses to the request the platform may utilize a plurality of machine learning models (e.g., a plurality of nodes) associated with one or more entities, users, organizations, or the like configured to compute a response associated with the request. One or more nodes of the plurality of nodes may need to communicate to generate one or more responses associated with the request received. As such, the method 1600 or method 1610 may be utilized for communication between one or more nodes of the plurality of nodes.

In reference to FIG. 16A, the method 1600 may begin at step 1601, where a message may be sent, by a first node (e.g., first node 1701) of a plurality of nodes. In some examples, the message may be a broadcast message. The message may be sent on a network (e.g., network 1505) to a plurality of nodes. The message may be sent based on a request from a user associated with the third-party platform 1520. In some examples, the message may be transmitted via a network device (e.g., network device 1510). In some examples, the information associated with the message may be stored in a database (e.g., data store 1508), a server (e.g., server 1507), or any other suitable component of system 1500.

At step 1602, the first node 1701 may receive one or more response messages to the message. The one or more response messages may be sent from one or more nodes of a plurality of nodes. The one or more response messages may comprise synchronization information associated with the information of step 1601. The one or more response messages may be sent on a network (e.g., network 1505) to a first node 1701. The one or more response messages may be sent based on the information received at step 1601. In some examples, the synchronization information associated with the one or more responses may be stored in a database (e.g., data store 1508), a server (e.g., server 1507), or any other suitable component of system 1500. In an example, the one or more nodes of the plurality of nodes that send the one or more response messages may be one or more nodes that have configurations compatible to the message sent at step 1601.

At step 1603, the first node 1701 may send computation data. The computation data may be sent to one or more nodes of the plurality of nodes. The computation data may be sent only to nodes that have sent one or more messages comprising synchronization information. The computation data may be associated with at least a portion of a response. In some examples, the computation data associated with the first node 1701 may be computed in tandem with the one or more nodes of the plurality of nodes. The computation data associated with the first node 1701 and the computation data of the one or more nodes of the plurality nodes may be utilized to determine a response to the request associated with a user of the third-party platform 1520.

In reference to FIG. 16B, the method 1610 may begin at step 1611, where a message may be received. The message may be received by a plurality of nodes. The message may comprise information associated with the first node. The information associated with the message may be stored in a database (e.g., data store 1508), server (e.g., 1507) associated with a network device 1510 or any other suitable device (e.g., node) of the system 1500.

At step 1612, one or more nodes of the plurality of nodes may send one or more response messages in response to the message of step 1611. The one or more response messages may be sent to a first node 1701. The one or more response messages may comprise synchronization information. The synchronization information may be stored in a database (e.g., data store 1608), server (e.g., server 1607) associated with a network device 1610 or any other suitable device (e.g., node) of the system 1600. The one or more response messages may be sent via a network 1505. The one or more nodes of the plurality of nodes may be nodes that have configurations that are similar to or suitable with the information associated with the message received at step 1611.

At step 1613, one or more nodes of the plurality of nodes may receive data associated with the first node 1701. The data may be computation data associated with a machine learning model. The received data may be of a data structure, or the like indicated by the message received at step 1611.

At step 1614, the one or more nodes of the plurality of nodes may execute computations, based on the synchronization information. The computations may be executed to generate a response to a request. The computations may include data from one or more nodes of a plurality of nodes and data associated with the first node 1701. The data form the one or more nodes of a plurality of nodes and data associated with the first node 1701 may be of a common form based on the synchronization information. The data associated with the one or more nodes of the plurality of nodes may be of similar data structure or the like based on the message received.

Although FIG. 16A and FIG. 16B shows example steps of the method 1600 and method 1610, respectively, in some examples, the method 1600 or method 1610 may include additional steps, fewer steps, different steps, or different arranged steps than those depicted in FIG. 16A or FIG. 16B. additionally, or alternatively, two or more steps of the method 1600 or the method 1610 may be performed in parallel.

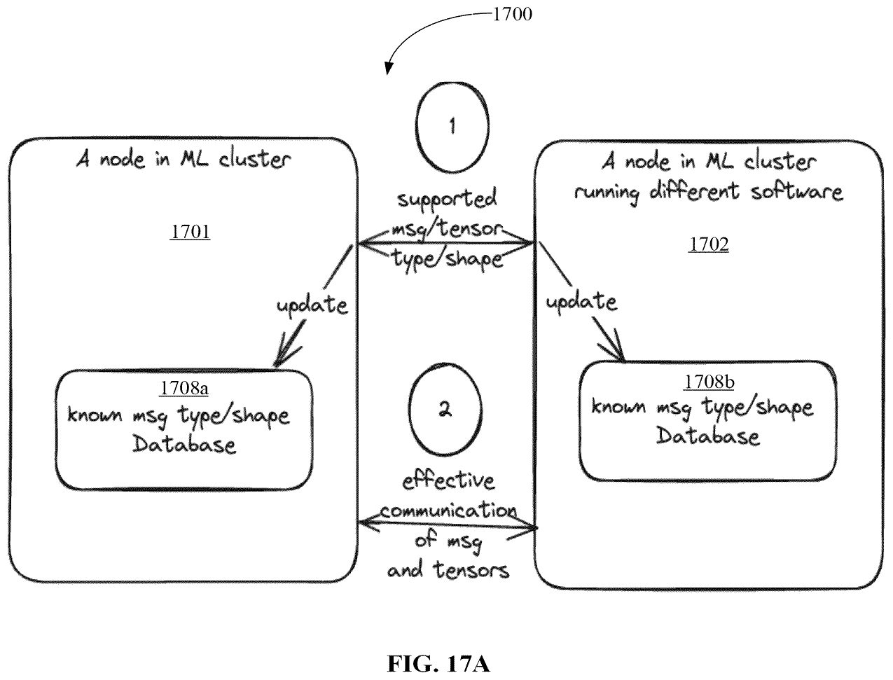

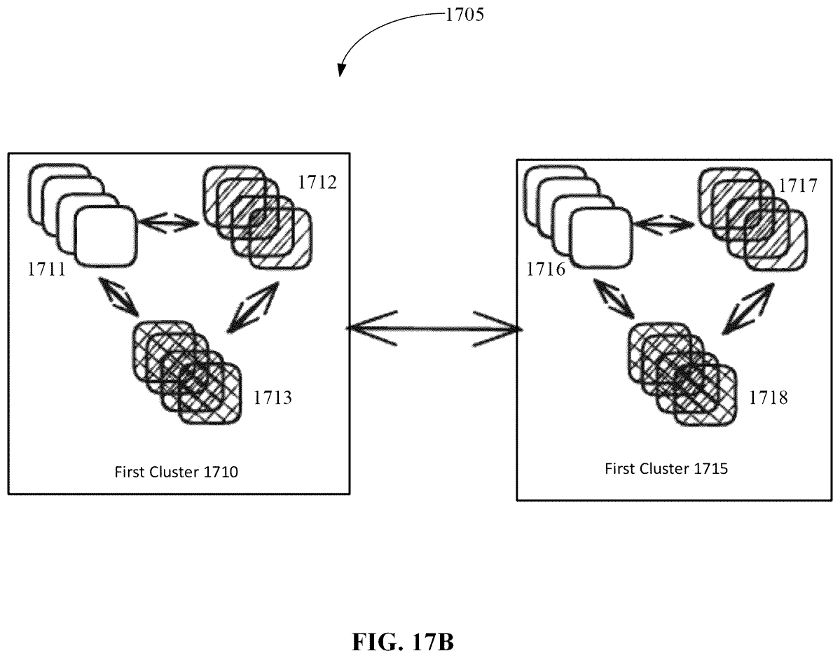

FIG. 17A illustrates an example system 1700, in an example of the present disclosure. The FIG. 17A may be illustrate the method 1600 of FIG. 16A or the method 1610 of FIG. 16B. The system 1700 may comprise a first node 1701 (e.g., device 1501, 1502, 1503) and a second node 1702 (e.g., device 1501, 1502, 1503). The first node 1701 may be associated with a first entity and the second node 1702 may be associated with a second entity. The first node 1701 may be machine learning training cluster and the second node 1702 may be a machine learning training cluster. The first entity and the second entity's training clusters (e.g., the first node 1701 and the second node 1702) may be utilize different software. The first node 1701 may be associated with a first format and the second node 1702 may be associated with a second format. As such, the data structure of the first node 1701 (e.g., the first format) may be different than the data structure of the second node 1702 (e.g., the second format).

In an example, a user may send a request via a third party platform 1520 that may need data from both the first node 1701 and the second node 1702 to generate a response. In such examples the method 1600 or method 1610 may be utilized such that the response may be generated (e.g., determined). For simplicity, the plurality of nodes of method 1600 or method 1610 may be discussed as the second node 1702. The first node 1701 may send a message to the second node 1702, via a network (e.g., network 1505). The message may comprise information, such as, one or more of a type, shape, list, or plural supported by the first node 1701 in response to the received request. The information may be saved to a database 1708b (e.g., data store 1508) associated with the second node 1702.

In response to receiving the message, the second node may send a response message. The response message may comprise synchronization information configured to establish or relay information between the first node 1701 and the second node 1702 such that the data that may be generated from the first node 1701 may be compatible with the second node 1702 and vice versa. The synchronization information may be saved to a database 1708a (e.g., data store 1508) associated with the first node 1701. It is contemplated that the databases 1708a,b may be physically located on the nodes of the system 1700 or on a network device (e.g., network device 1510). It is contemplated that the information or the synchronization information may be stored temporarily or permanently for future communication between the first node 1701 and the second node 1702.

The first node 1701 may now send data associated with generating the response. Conversely, the second node 1702 may also send data associated with generating the response. The data associated with the first node 1701 may be of a first structure and the data associated with the second node 1702 may be of the first format. The data from the first node 1701 and the second node 1702 both being in the first format may allow for the system 1700 to execute computations to generate a response associated with the request. The first format may be considered a common language between the first node 1701 and the second node 1702. The common language may be one or more of a type, shape, list, or plural, that may be supported by the second node 1702 and the first node 1701 based on the information associated with the first node 1701.

FIG. 17B illustrates an example flow 1705 associated with an example of the present disclosure. The flow 1705 may illustrate a first training cluster 1710 and a second training cluster 1715. The first training cluster 1710 may comprise a first plurality of nodes (e.g., node 1711, 1712, 1713). The second training cluster 1715 may comprise a second plurality of nodes (e.g., node 1716, 1717, 1718). The plurality of nodes (e.g., node 1711, 1712, 1713, 1716, 1717, 1718) may comprise a number of nodes. For simplicity, the number of nodes may be configured to communicate between one or more nodes of the number of nodes in a common language. In an alternate example, the number of nodes may be configured to communicatee between one or more nodes of the number of nodes using the method 1600 or method 1610 of FIG. 16A or FIG. 16B. The first plurality of nodes (e.g., node 1711, 1712, 1713) may be configured to communicate between one or more nodes of the first plurality of nodes, where one or more nodes of the first plurality of nodes are in a first format. The second plurality of nodes (e.g., node 1716, 1717, 1718) may be configured to communicate between one or more nodes of the second plurality of nodes, where one or more nodes of the second plurality of nodes are in a second format. In this example, data from the first training cluster 1710 may be in the first format and data from the second training cluster 1715 may be in the second format. As such, the method 1600 or method 1610 may be utilized on the first training cluster 1710 and the second training cluster 1715 to find a common language between the two clusters such that a response may be generated.

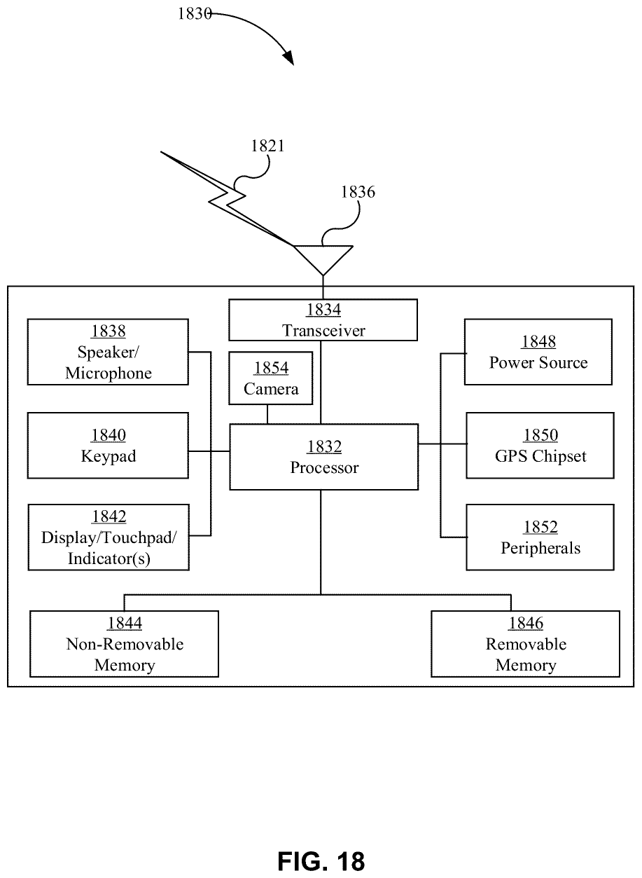

FIG. 18 illustrates a block diagram of an example hardware/software architecture of user equipment (UE) 1830. As shown in FIG. 18, the UE 1830 (also referred to herein as node 1830) may include a processor 1832, non-removable memory 1844, removable memory 1846, a speaker/microphone 1838, a keypad 1840, a display, touchpad, and/or indicators 1842, a power source 1848, a global positioning system (GPS) chipset 1850, and other peripherals 1852. The UE 1830 may also include a camera 1854. In an example, the camera 1854 is a smart camera configured to sense images appearing within one or more bounding boxes. The UE 1830 may also include communication circuitry, such as a transceiver 1834 and a transmit/receive element 1836. It will be appreciated that the UE 1830 may include any sub-combination of the foregoing elements while remaining consistent with an example.

The processor 1832 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 1832 may execute computer-executable instructions stored in the memory (e.g., memory 1844 and/or memory 1846) of the node 1830 in order to perform the various required functions of the node. For example, the processor 1832 may perform signal coding, data processing, power control, input/output processing, and/or any other functionality that enables the node 1830 to operate in a wireless or wired environment. The processor 1832 may run application-layer programs (e.g., browsers) and/or radio access-layer (RAN) programs and/or other communications programs. The processor 1832 may also perform security operations such as authentication, security key agreement, and/or cryptographic operations, such as at the access-layer and/or application layer for example.

The processor 1832 is coupled to its communication circuitry (e.g., transceiver 1834 and transmit/receive element 1836). The processor 1832, through the execution of computer executable instructions, may control the communication circuitry in order to cause the node 1830 to communicate with other nodes via the network to which it is connected.

The transmit/receive element 1836 may be configured to transmit signals to, or receive signals from, other nodes or networking equipment. For example, in an example, the transmit/receive element 1836 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 1836 may be configured to transmit and receive both RF and light signals. It will be appreciated that the transmit/receive element 1836 may be configured to transmit and/or receive any combination of wireless or wired signals.

The transceiver 1834 may be configured to modulate the signals that are to be transmitted by the transmit/receive element 1836 and to demodulate the signals that are received by the transmit/receive element 1836. As noted above, the node 1830 may have multi-mode capabilities. Thus, the transceiver 1834 may include multiple transceivers for enabling the node 1830 to communicate via multiple radio access technologies (RATs), such as universal terrestrial radio access (UTRA) and Institute of Electrical and Electronics Engineers (IEEE 802.11), for example.

The processor 1832 may access information from, and store data in, any type of suitable memory, such as the non-removable memory 1844 and/or the removable memory 1846. For example, the processor 1832 may store session context in its memory, as described above. The non-removable memory 44 may include RAM, ROM, a hard disk, or any other type of memory storage device. The removable memory 1846 may include a subscriber identity module (SIM) card, a memory stick, a secure digital (SD) memory card, and the like. In other examples, the processor 1832 may access information from, and store data in, memory that is not physically located on the node 1830, such as on a server or a home computer.

The processor 1832 may receive power from the power source 1848 and may be configured to distribute and/or control the power to the other components in the node 1830. The power source 1848 may be any suitable device for powering the node 1830. For example, the power source 1848 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1832 may also be coupled to the GPS chipset 1850, which may be configured to provide location information (e.g., longitude and latitude) regarding the current location of the node 1830. It will be appreciated that the node 1830 may acquire location information by way of any suitable location-determination method while remaining consistent with an example.

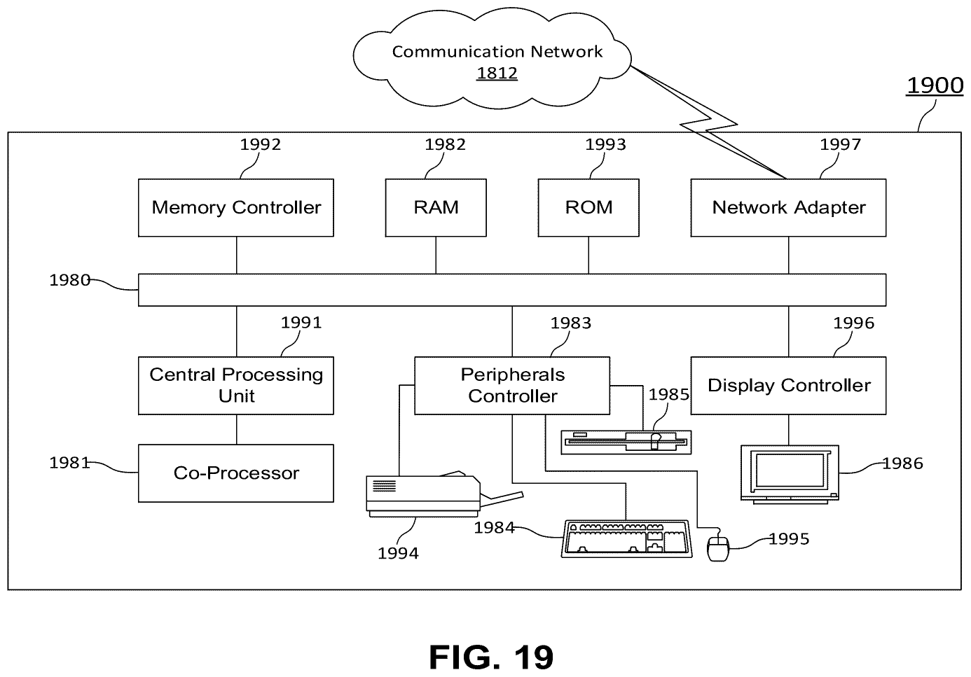

FIG. 19 is a block diagram of an exemplary computing system 1900. In some exemplary embodiments, the network device 1510 may be a computing system 1900. The computing system 1900 may comprise a computer or server and may be controlled primarily by computer readable instructions, which may be in the form of software, wherever, or by whatever means such software is stored or accessed. Such computer readable instructions may be executed within a processor, such as central processing unit (CPU) 1991, to cause computing system 1900 to operate. In many workstations, servers, and personal computers, central processing unit 1991 may be implemented by a single-chip CPU called a microprocessor. In other machines, the central processing unit 1991 may comprise multiple processors. Coprocessor 1981 may be an optional processor, distinct from main CPU 1991, that performs additional functions or assists CPU 1991.

In operation, CPU 1991 fetches, decodes, and executes instructions, and transfers information to and from other resources via the computer's main data-transfer path, system bus 1980. Such a system bus connects the components in computing system 500 and defines the medium for data exchange. System bus 1980 typically includes data lines for sending data, address lines for sending addresses, and control lines for sending interrupts and for operating the system bus. An example of such a system bus 1980 is the Peripheral Component Interconnect (PCI) bus.

Memories coupled to system bus 1980 include RAM 1982 and ROM 1993. Such memories may include circuitry that allows information to be stored and retrieved. ROMs 1993 generally contain stored data that cannot easily be modified. Data stored in RAM 1982 may be read or changed by CPU 91 or other hardware devices. Access to RAM 1982 and/or ROM 1993 may be controlled by memory controller 1992. Memory controller 1992 may provide an address translation function that translates virtual addresses into physical addresses as instructions are executed. Memory controller 1992 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 1900 may contain peripherals controller 1983 responsible for communicating instructions from CPU 1991 to peripherals, such as printer 1994, keyboard 1984, mouse 1995, and disk drive 1985.

Display 1986, which is controlled by display controller 1996, is used to display visual output generated by computing system 1900. Such visual output may include text, graphics, animated graphics, and video. Display 1986 may be implemented with a cathode-ray tube (CRT)-based video display, a liquid-crystal display (LCD)-based flat-panel display, gas plasma-based flat-panel display, or a touch-panel. Display controller 1996 includes electronic components required to generate a video signal that is sent to display 1986.

Further, computing system 1900 may contain communication circuitry, such as for example a network adaptor 1997, that may be used to connect computing system 500 to an external communications network, such as network 1821 of FIG. 18, to enable the computing system 1900 to communicate with other nodes (e.g., UE 1830) of the network.

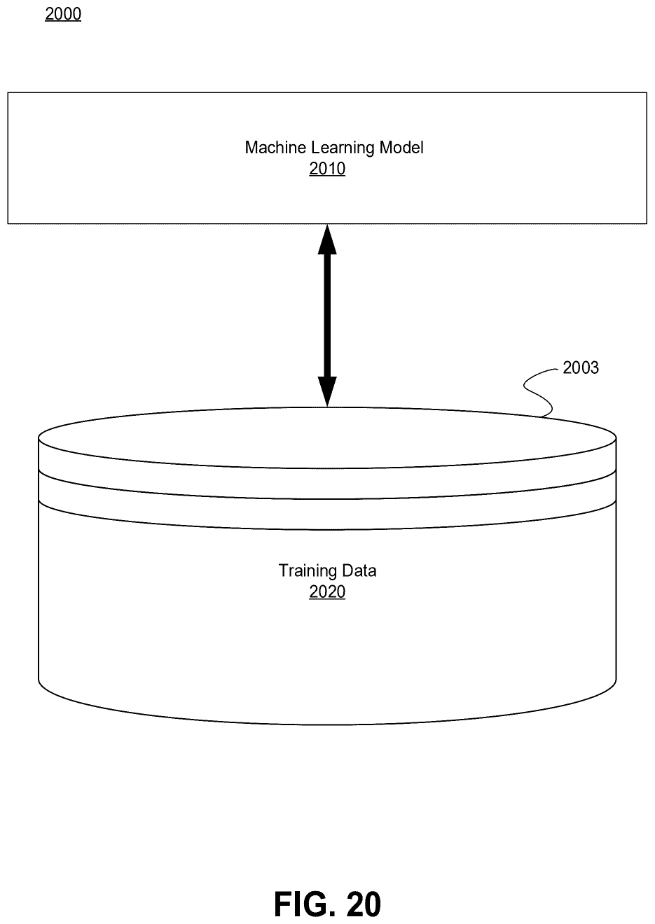

FIG. 20 illustrates a framework 2000 associated with machine learning and/or artificial intelligence (AI). The framework 2000 may be hosted remotely. Alternatively, the framework 2000 may reside within the system 1500 shown in FIG. 15 and may be processed/implemented by a device. In some examples, the machine learning model 2010 (also referred to herein as artificial intelligence model 2010) may be implemented/executed by a network device (e.g., network device 1510). In other examples, the machine learning model 2010 may be implemented/executed by other devices (e.g., communication devices 1501, 1502, 1503). The machine learning model 2010 may be operably coupled with the stored training data in a training database 2003 (e.g., data store 1508). In some examples, the machine learning model 2010 may be associated with other operations. The machine learning model 2010 may be one or more machine learning models.

In another example, the training data 2020 may include attributes of thousands of objects. For example, the objects may be a smart phone, person, book, newspaper, sign, car, item and/or the like. Attributes may include but are not limited to the size, shape, orientation, position of the object(s), etc. The training data 2020 employed by the machine learning model 2010 may be fixed or updated periodically. Alternatively, the training data 2020 may be updated in real-time based upon the evaluations performed by the machine learning model 2010 in a non-training mode. This is illustrated by the double-sided arrow connecting the machine learning model 2010 and stored training data 2020.

In operation, the machine learning model 2010 may evaluate associations between a request and a response. For example, a request (e.g., a search, interaction with a content item, etc.) may be compared with respective attributes of stored training data 2020 (e.g., prestored objects) to generate a response.

Typically, such determinations by some existing systems may require a large quantity of manual annotation(s) and/or brute force computer-based annotation to obtain the training data in a supervised training framework. However, example aspects of the present disclosure may deploy a machine learning model(s) (e.g., machine learning model 2010) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 2010. As such, this enables one or more user inputs, requests for programmable code to solve one or more problems, or other aspects of the examples of the present disclosure to be flexible and scalable to billions of users, and their associated communication devices, on a network device.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Methods, systems, or apparatus with regard to distributed model communication are disclosed herein. A method, system, or apparatus may provide for receiving, by a first model, a message format request from a second model; transmitting, by the first model, a supported message format to the second model; recording, by the first model, message format capabilities of the second model in a database; receiving a message from the second model according to the supported message format; and processing the message based on the recorded message format capabilities. The message format request may comprise at least one of: a tensor shape; a tensor type; a data format; or a communication protocol. The method may include determining whether the second model can process messages in a format supported by the first model; and adapting the message to a mutually supported format before transmission. The method may include broadcasting supported message formats to multiple models in a distributed system; receiving message format capabilities from the multiple models; and updating the database with format capabilities for each model. The first model may execute on a first computing resource type and the second model may execute on a second computing resource type different from the first computing resource type, where the supported message format enables communication between the different computing resource types. The method may include detecting a new model joining a distributed system; exchanging message format capabilities with the new model; and updating the database with format capabilities of the new model. The method may include monitoring performance metrics of message exchanges; determining that a metric exceeds a threshold; and adapting the supported message format based on the performance metrics. The method may include maintaining multiple message format profiles for different types of communications; selecting a format profile based on a type of message to be exchanged; and configuring message exchanges according to the selected profile. The first model may provide first functionality, and the second model may provide second functionality different from the first functionality, where the message exchange enables collaborative processing between the models. All combinations (including the removal or addition of steps) in this paragraph are contemplated in a manner that is consistent with the other portions of the detailed description.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
compressing, using a compression operation, each training panoramic image in a set of training panoramic images into a corresponding compressed training panoramic image, the compressing resulting in a set of compressed training panoramic images;
training, using the set of compressed training panoramic images, a transformer model to generate compressed panoramic images, the training resulting in a trained transformer model;
generating, using the trained transformer model, a first compressed panoramic image; and
expanding, using an inverse of the compression operation, the first compressed panoramic image into an uncompressed panoramic image.

2. The computer-implemented method of claim 1, wherein the compression operation performs a vertical compression of an input image.

3. The computer-implemented method of claim 1, wherein the inverse of the compression operation expands a compressed input image vertically.

4. A system comprising:
a non-transitory memory with instructions stored thereon; and
a processor operably coupled to the non-transitory memory and configured to execute the instructions of:
receiving real-time audio via a speaker;
processing the received audio via a trained semi-supervised machine learning model, wherein the processing instruction includes noise suppression or echo cancellation;
generating an audio quality score for the processed audio;
encoding the processed audio; and
transmitting the encoded audio to a receiver.

5. A method comprising:
sending, by a first node of a plurality of nodes, a message, wherein the message comprises information associated with the first node of the plurality of nodes;
receiving, from one or more nodes of the plurality of nodes, one or more response messages to the message; and
sending, by the first node of the plurality of nodes, data associated with computations at the first node.

6. The method of claim 5, wherein the one or more response messages comprise synchronization information.

7. The method of claim 5, further comprising:
receiving, from the first node to one or more nodes of the plurality of nodes, data associated with computations at the first node; and
executing computations, based on synchronization information, to generate a response.
